(19) United States
(12) Patent Application Publication
(10) Pub. No.: US 2024/0171402 A1
(43) Pub. Date: May 23, 2024

(54) AUTHENTICATION METHODS USING ZERO-KNOWLEDGE PROOF ALGORITHMS FOR USER EQUIPMENT AND NODES IMPLEMENTING THE AUTHENTICATION METHODS

(71) Applicant: HUAWEI TECHNOLOGIES CO., LTD., Shenzhen (CN)

(72) Inventors: Gholamreza RAMEZAN, Kanata (CA); Amr Adel Nasr ABDELNASSER, Kanata (CA); Fei YANG, Beijing (CN); Weiyu JIANG, Beijing (CN); Bingyang LIU, Shenzhen (CN)

(21) Appl. No.: 18/418,589

(22) Filed: Jan. 22, 2024

Related U.S. Application Data
(63) Continuation of application No. PCT/CN2021/107819, filed on Jul. 22, 2021.

(51) Int. Cl. H04L 9/32

(52) U.S. Cl. CPC H04L 9/3218

(57) ABSTRACT

An authentication method for a target device, the method comprising authenticating, at an access network, a first identity of the target device for registering on the access network. In response to a successful authentication of the first identity by the access network, the method comprises executing, at the access network, a zero-knowledge proof (ZKP) protocol to authenticate a second identity of the target device for accessing a service provider; and, in response to a successful authentication of the second identity, granting, by the access network, access of the target device to the service provider.

### CROSS-REFERENCE TO RELATED APPLICATIONS

The present patent application is a continuation application of the International Patent Application No. PCT/CN2021/107819 filed on Jun. 22, 2021, an entirety of a content thereof is incorporated herein by reference.

### TECHNICAL FIELD

The present disclosure generally relates to the field of authentication methods in communication networks and, in particular, to authentication methods using zero-knowledge proof algorithms for user equipment and to nodes implementing the authentication methods.

### BACKGROUND

Fifth generation (5G) wireless network technology, which was first standardized by the Third Generation Partnership Project (3GPP) in its Release 15 has extended the previous wireless generations by connecting things to the Internet and to other things. The combination of 5G and the Internet of Things (IoT) has added emerging applications and use cases including augmented reality and virtual reality, private factory networks, transportation, manufacturing, health and education. Furthermore, the 5G standardization efforts have progressed steadily towards Beyond 5G as evident in the works done by 3GPP in Release 16 and Release 17.

However, with the ongoing development of wireless networking technologies, there are expectations for stronger security guarantees as well. The authentication and key agreement (AKA) scheme is one critical step towards strong security guarantees. The main concern in authentication is to guarantee that the correct parties are communicating with each other. On the other hand, the key agreement is concerned with obtaining good cryptographic keys to provide data confidentiality and integrity. AKA is accomplished by running an authentication protocol between the subscriber and the network.

In this context, 3GPP has defined two authentication procedures which are the primary authentication and the secondary authentication. These two authentication procedures enable 5G to define a model with two parties which are mobile network operators (MNOs) and the service providers (SPs). MNOs deploy and manage physical networks and SPs lease resources from one or more MNOs and create services for mobile subscribers. The purpose of the primary authentication is to enable the mutual authentication between a user equipment (UE) and the 5G MNO core network (CN). Fifth generation authentication and key agreement (5G AKA) and improved extensible authentication protocol-authentication and key agreement (EAP-AKA′) are two well-known protocols for the primary authentication. The secondary authentication is only enabled after a successful primary authentication. It enables authentication between a UE (identified by a data network (DN)-specific identity) and an external DN authentication, authorization, and accounting (DN-AAA) server belonging to an SP. EAP transport layer security (EAP-TLS) and EAP tunneled transport layer Security (EAP-TTLS) are two well-known protocols for the secondary authentication.

In a denial of service (DoS) attack, an adversary seeks to make a network node or a resource unavailable, thus the services are denied for all users including the legitimate users. A distributed DoS (DDoS) attack occurs when a network is flooded by incoming traffic originating from many different sources. Due to the heterogeneity of the offered services and the requirements to support IoT and mission-critical applications in 5G, DDoS attacks during primary and secondary authentications are even more challenging. Realizing the severity of DDoS attacks on the 5G CN, 3GPP has enhanced the authentication procedures in 5G and beyond in Release 17 in order to mitigate DDoS attacks on the CN.

Different security frameworks have been proposed in the literature that rely on the idea of edge computing. Some of those frameworks comprise an architecture that makes the edge the first line of defense against IoT-DDoS attacks. Some other frameworks introduce a novel collaborative DDoS defense architecture that mitigates the attack traffic from devices that are mobile. However, both approaches only mitigate those attacks that take place due to Hypertext Transfer Protocol (HTTP) flooding or User Datagram Protocol (UDP) flooding, and do not mitigate DDoS attacks that take place during the authentication process. Other approaches proposed authentication architectures that rely on moving the authentication process from the core network to decentralized nodes at the network edge. This necessitates to store and distribute all the authentication data among the distributed authentication entities at the network edge which is impractical and could be infeasible to implement. Moreover, such a distribution may lead to security breach and inability to maintain secrecy of the subscriber's credential as they are transmitted to a plurality of authentication entities. To address the possibility of launching a DDoS attack on the 5G network due to the frequent passing of the secondary authentication traffic, various security schemes to mitigate DDoS proposed to relay the secondary authentication process to take place in the middle of the 5G network. However, to accomplish this task, these frameworks had to introduce two newly defined network functions (NFs) to the 5G network that perform the secondary authentication on behalf of the DN-AAA server. Moreover, the introduced NFs have to interact with the DN-AAA server (i.e. engage it) even though the secondary authentication with the UE is not done yet.

Consequently, there is a need for solutions that mitigate DDoS attacks by performing authentication processes at the edge of the 5G CN while maintaining secrecy of the subscriber's credentials.

### SUMMARY

An aspect of the present disclosure is to provide an authentication method for a target device. The method comprises authenticating, at an access network, a first identity of the target device for registering on the access network. In response to a successful authentication of the first identity by the access network, the method comprises executing, at the access network, a zero-knowledge proof (ZKP) protocol to authenticate a second identity of the target device for accessing a service provider; and, in response to a successful authentication of the second identity, granting, by the access network, access of the target device to the service provider.

In at least one embodiment, the method further comprises receiving a registration request from the target device at the access network, wherein authenticating the first identity of the target device is made in response to receiving the registration request.

In at least one embodiment, the method further comprises receiving a service request from the target device at the access network, wherein executing the zero-knowledge proof protocol to authenticate the second identity of the target device is made in response to receiving the service request.

In at least one embodiment, the method further comprises a setup phase. The setup phase comprises generating, at the target device, a first credential identity, a second credential identity, and a credential secret, the first and second credential identities and the credential secret being associated with the second identity of the target device. The setup phase further comprises transmitting, by the target device on a communication channel to an authentication managing entity, a second information comprising the first and second credential identities and the credential secret. The setup phase further comprises transmitting, by the authentication managing entity on the communication channel to the target device, a first set of partial credential keys, the partial credential keys of the first set of partial credential keys being based on the first and second credential identities and on the credential secret. The setup phase further comprises transmitting, by the authentication managing entity on the communication channel to a first authenticating entity of the access network, the first credential identity and a second set of partial credential keys; and transmitting, by the authentication managing entity on the communication channel to a second authenticating entity of the access network, the second credential identity and the second set of partial credential keys.

In at least one embodiment, the first credential identity and the second credential identity are generated based on random selection among a plurality of credential identities.

In at least one embodiment, the setup phase is executed before authenticating the second identity of the target device for accessing the service provider.

In at least one embodiment, the execution of the ZKP protocol comprises, after receiving the service request, executing, by the first authenticating entity of the access network, a first ZKP authentication procedure to determine whether the target device has a valid first credential identity and a valid credential secret without revealing the credential secret to the first authenticating entity; and, in response to determining, based on a result of the first ZKP authentication procedure, that the target device has a valid first credential identity and a valid credential secret, executing, by the second authenticating entity of the access network, a second ZKP authentication procedure to determine whether the target device has a valid second credential identity and a valid credential secret without revealing the credential secret to the second authenticating entity. In this at least one embodiment, the authentication managing entity grants access of the target device to the service provider in response to determining, based on a result of the second ZKP authentication procedure, that the target device has a valid second credential identity and a valid credential secret.

In at least one embodiment, executing, by the first authenticating entity of the access network, the first ZKP authentication procedure comprises transmitting, by the target device on the access network to the first authenticating entity, a subset of the first set of partial credential keys.

In at least one embodiment, executing, by the second authenticating entity of the access network, the second ZKP authentication procedure comprises transmitting, by the target device on the access network to the second authenticating entity, a subset of the first set of partial credential keys.

Another object of the present disclosure is to provide an authentication method for a user equipment (UE) communicably connected to a 5G access network (AN). The authentication method comprises executing, at the 5G AN, a primary authentication of the UE for registering on the 5G AN. The method comprises, in response to a successful primary authentication of the UE, executing, at the 5G AN, a secondary authentication of the UE for accessing a service provider based on a zero-knowledge proof protocol; and in response to a successful secondary authentication, granting, by the 5G AN, access of the UE to the service provider.

In at least one embodiment, executing, at the 5G AN, the secondary authentication of the UE comprises transmitting an identity request from a session management function (SMF) to the UE.

In at least one embodiment, granting, by the 5G AN, access of the UE to the service provider comprises receiving at the SMF, a signal indicative of a success of an execution of the zero-knowledge proof protocol.

In at least one embodiment, the primary authentication is executed by a authentication server function (AUSF) of the 5G AN based on a protocol selected from a group of protocols comprising: fifth generation authentication and key agreement (5G AKA) protocol and improved extensible authentication protocol-authentication and key agreement (EAP-AKA′) protocol.

In at least one embodiment, the method further comprises receiving a registration request from the UE at the 5G AN, wherein the primary authentication is executed in response to receiving the registration request.

In at least one embodiment, the method further comprises receiving a packet data unit (PDU) session establishment request from the UE at the 5G AN, wherein executing the secondary authentication based on the zero-knowledge proof protocol is made in response to receiving the PDU session establishment request.

In at least one embodiment, the method further comprises a setup phase. The setup phase comprises generating at the UE a first credential identity, a second credential identity, and a credential secret associated with the secondary authentication of the UE; transmitting, by the UE on a communication channel to a server of the service provider, a second information comprising the first and second credential identities and the credential secret; transmitting, by the server of the service provider on the communication channel to the UE, a first set of partial credential keys, the plurality of partial credential keys being based on the first and second credential identities and on the credential secret; transmitting, by the server of the service provider on the communication channel to an access and mobility management function (AMF) of the 5G AN, the first credential identity and a second set of partial credential keys; and transmitting, by the server of the service provider on the communication channel to a data network-authentication, authorization and accounting (DN-AAA) server of the access network, the second credential identity and the second set of partial credential keys.

In at least one embodiment, the first credential identity is a 5G subscription permanent identifier (SUPI) of the UE, and the second credential identity is a service provider user identifier (SP user ID).

In at least one embodiment, the setup phase is executed before executing the secondary authentication of the UE for registering on the 5G AN.

In at least one embodiment, the execution of the secondary authentication based on the ZKP protocol comprises executing, by the AMF, a first ZKP authentication procedure to determine whether the UE has a valid first credential identity and a valid credential secret without revealing the credential secret to the AMF; and in response to determining, based on a result of the first ZKP authentication procedure, that the UE has a valid first credential identity and a valid credential secret, executing, by the DN-AAA server of the access network, a second ZKP authentication procedure to determine whether the UE has a valid second credential identity and a valid credential secret without revealing the credential secret to the DN-AAA server; wherein the 5G AN grants access of the UE to the service provider in response to determining, based on a result of the second ZKP authentication procedure, that the UE has a valid second credential identity and a valid credential secret.

### BRIEF DESCRIPTION OF THE FIGURES

The features and advantages of the present disclosure will become apparent from the following detailed description, taken in combination with the appended drawings, in which:

FIG. 1 shows a simplified version of a 5G architecture defined in 3GPP 5G specifications;

FIG. 2 summarizes the original 5G UE registration procedure described in 3GPP 5G specifications;

FIG. 3 illustrates a secondary authentication procedure involving a malicious UE and an external DN-AAA server;

FIGS. 4a, 4b and 4c are flow diagrams of an authentication method for a target device to be granted access to a service provider according to an embodiment of the present technology;

FIG. 5a shows a setup phase of a partial-identity zero-knowledge-proof (Partial-ID ZKP) authentication procedure according to an embodiment of the present technology;

FIGS. 5b and 5c show an authentication phase of the Partial-ID ZKP authentication procedure according to an embodiment of the present technology;

FIGS. 6a, 6b and 6c are flow diagrams of an authentication method for a user equipment (UE) communicably connected to a 5G access network (AN) to be granted access to a service provider according to an embodiment of the present technology;

FIG. 7a show an authentication request procedure in the 5G AN;

FIGS. 7b and 7c show an authentication phase of an EAP-ZKP authentication procedure according to an embodiment of the present technology;

FIG. 8 is a schematic block diagram of a user equipment (UE) according to an embodiment of the present technology; and

FIG. 9 is a line chart showing average authentication times for the secondary authentication using the EAP-ZKP authentication protocol according to an embodiment of the present technology for different numbers of DDoS attack attempts compared with average authentication times of different authentication protocols.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

Various representative embodiments of the disclosed technology will be described more fully hereinafter with reference to the accompanying drawings, in which representative embodiments are shown. The presently disclosed technology may, however, be embodied in many different forms and should not be construed as limited to the representative embodiments set forth herein. Rather, these representative embodiments are provided so that the disclosure will be thorough and complete, and will fully convey the scope of the present technology to those skilled in the art. In the drawings, the sizes and relative sizes of layers and regions may be exaggerated for clarity. Like numerals refer to like elements throughout. And, unless otherwise defined, all technical and scientific terms used herein have the same meaning as commonly understood by one of ordinary skill in the art to which the described embodiments pertain.

Generally speaking, 5G has introduced two types of authentication procedures, which are the primary and secondary authentications. Both procedures are used to authenticate the user equipment (UE) requesting access to mobile network operators (MNOs) and service providers (SPs) data networks. Many SPs may benefit from the present technology, including for example and without limitation bank portals, social networks such as Facebook™ and Twitter™, or streaming media providers such as Netflix™ and Disney Channel™. However, the possibility of running distributed denial of service (DDoS) attacks on the MNO 5G core network (CN) and on the SPs data networks still remains. The present disclosure introduces a zero-knowledge proof (ZKP) authentication algorithm called Partial-ID ZKP that authenticates users without revealing their service credentials. ZKP refers to methods and protocols in which one party (a target device, also referred to as a “prover”) may prove to another party (a “verifier” that, in this embodiment, comprises a first and a second authenticating entities) that it knows a secret without conveying any information apart from the fact that it knows the secret. Such methods and protocols are used to prove such possession without revealing the secret itself or any additional information. The proofs of knowing a secret in ZKP are probabilistic rather than absolute, which means that there may be a probability of an illegitimate prover convincing a verifier about knowing a secret. Non-interactive zero-knowledge proofs (NIZKP) are a variant of ZKPs that reduces the interaction between the prover and the verifier. In other words, a common reference string shared between the prover and the verifier is sufficient to achieve zero-knowledge proof without requiring interactions that are usually needed in ZKP protocols. As will be described in greater details herein below, the Partial-ID ZKP algorithm has completeness and soundness properties. Based on the Partial-ID ZKP algorithm, the present disclosure further introduces an EAP-ZKP authentication protocol suitable for both the primary and secondary authentications to mitigate DDoS attacks at the CN edge.

This protocol prevents UEs and IoT devices from sending fake authentication requests to the 5G CN or to the DN-AAA server via MNO's network. Therefore, illegitimate UEs and IoT devices are prevented from performing DDoS attacks on 5G CN and SP's services. As it will be understood, the EAP-ZKP authentication protocol performs the authentication process at the edge of the 5G CN in contrast to the current 5G that performs the authentication further inside the 5G CN or at the DN-AAA server. It utilizes zero-knowledge proof (ZKP) methods so as to prove an identity of a user to the CN without revealing the user's credentials. Besides, said authentication protocol may be provided, in part, at the edge of the 5G CN, thus protecting other 5G components inside the 5G CN as well as the SP's DN from DDoS attacks on their authentication servers.

It should be understood that, while 5G networks support mobility of users (or subscribers) and of their equipment (called “user equipment”—UE), it is expected that many users and user devices may be stationed in fixed locations. Non-limiting examples may include a variety of devices used in the context of so-called “Internet of Things” (IoT). For that reason, in the context of the present disclosure, mentions of “5G mobile communication networks” and similar mentions do not limit the generality of the present disclosure, which may equally apply to fixed and mobile users as well as to fixed and mobile UEs.

It should also be understood that the present authentication protocol is not limited to cellular communications in 5G networks, i.e. between a mobile device and the 5G core network. For example and without limitation, the present authentication protocol may be employed as part of registration procedures in Autonomous Vehicles (Vehicular networks), IoT in Smart City Infrastructure, Traffic Management, and Industrial Automation, Augmented Reality and Virtual Reality, Drones, and Wearables.

In the context of the present disclosure, the terms “user”, “subscriber” and “UE” may sometimes be used interchangeably. A subscriber generally refers to a person or other entity that owns a subscription to a service and pays for the subscription. A user usually refers to a person who may be distinct from the paying subscriber and who is distinct from the UE. As such, a user may not be able to send and receive signals to and from a network, as signaling exchanges take place between a user device, the UE, and the network. In the context of IoT, a user may be a device connected to a UE. The present disclosure uses the terms “user”, “subscriber” and “UE” in a manner that is intended to simplify the illustration of the various embodiments, without any intent to limit the generality of the disclosed technology.

The present authentication protocol may be implemented in the existing 5G networks with minimal changes to the 3rd generation partnership project (3GPP) 5G specifications.

The present technology is introduced from a technical perspective, followed by an assessment of its feasibility. A formal authentication protocol using a ZKP authentication algorithm and its implementation in the EAP authentication framework and in 5G authentications are disclosed. A comparison of performances of the present ZKP-based authentication protocol with 5G-AKA and EAP-AKA′ is further provided.

### I. Overview of the 5G System

### I-A. 5G Core Network Architecture

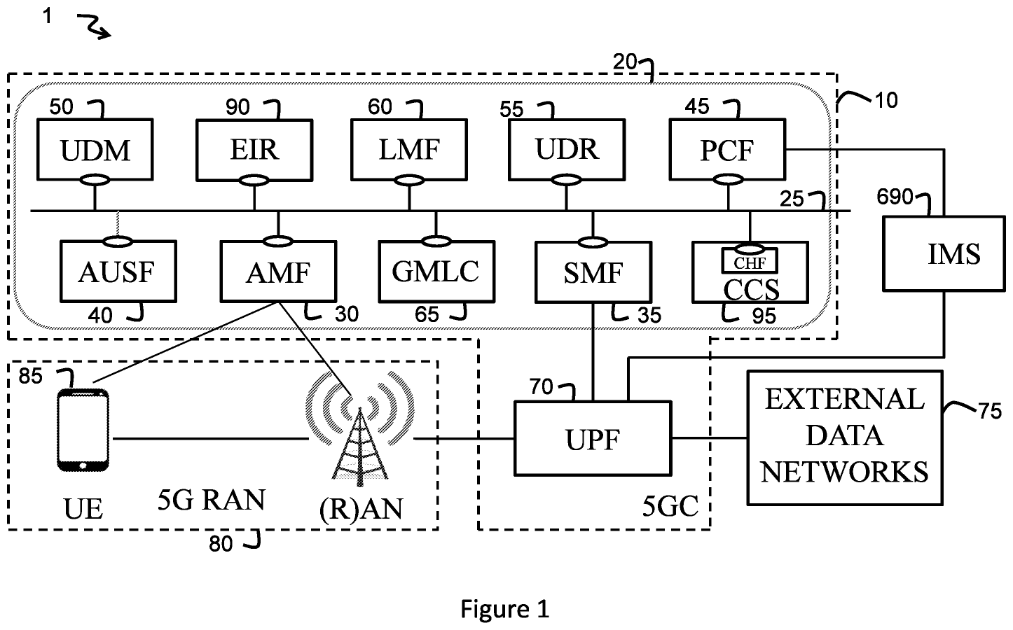

FIG. 1 shows a simplified version of a 5G architecture 1 defined in 3GPP 5G specifications. In the 5G architecture 1, a 5G CN 10 adopts a separation between a control plane and a user plane to allow for scalability and flexible deployment of 5G services. The upper part of the 5G CN 10 in FIG. 1 constitutes the control plane where each network function interacts in a service-based architecture 20 and exposes its functionality through a service-based interface 25. Example of network functions in the control plane include an access and mobility management function (AMF) 30, a session management function (SMF) 35, an authentication server function (AUSF) 40, a policy control function (PCF) 45, a unified data management (UDM) 50, a unified data repository (UDR) 55, an equipment identity register (EIR) 90 (also referred to as 5G-EIR in the present specification), a converged charging system (CCS) 95 that includes a charging function (CHF), a location management function (LMF) 60, and a gateway mobile location center (GMLC) 65. These network functions interact over the service-based interface 25, as shown in FIG. 1.

The AMF 30 is responsible for non-access stratum ciphering and integrity protection, registration management, connection management, mobility management, and access authentication and authorization. The SMF 35 is responsible for session management, Internet Protocol (IP) address allocation and management for the user/subscriber, and termination of non-access stratum signaling related to session management. The AUSF 40 acts as an authentication server. The PCF 45 provides policy rules to functions of the control plane and provides access subscription information for policy decisions in the UDR 55. The UDM 50 is responsible for the generation of authentication and key agreement (AKA) credentials, user identification handling, access authorization, and subscription management. The 55 UDR is responsible for storage and retrieval of subscription data by the UDM 50, of policy data by the PCF 45, and of structured data for exposure. The EIR 90 holds information about the mobile devices serial numbers and whether they are blacklisted or not. This information held by the EIR 90 may comprise a permanent equipment identifier (PEI) for each mobile device. The CCS 95 is responsible for subscriber charging and provides an interface with the billing domain The LMF 60 is responsible for location determination for a user and obtaining location measurements. The GMLC 65 supports location services.

The lower part of the 5G CN 10 forms the user plane, including a user plane function (UPF) 70, which is responsible for packet routing and forwarding, packet inspection, quality of service handling, and acts as an external packet data unit (PDU) session point of interconnect to external data networks (DN) 75. The 5G CN 10 operates jointly with a 5G radio access network (RAN) 80 to provide access, to one or more UEs 85, to services of the 5G CN 10 and of the external data networks (DN) 75. Finally, the IP multimedia subsystem (IMS) 690 is a subsystem that 5G relies on for providing voice and multimedia services.

### I-B. 5G Identifiers

In 5G, several identifiers are used at the user level and at the equipment level (i.e. at the UE 85). Some of these identifiers are permanent, whereas, to support user confidentiality protection, other identifiers are dynamic. The relevant identifiers to the present technology comprise permanent identifiers, which include the SUPI, the PEI, and the GPSI, as mentioned hereinabove, as well as dynamic identifiers, which include the subscription concealed identifier (SUCI), the 5G globally unique temporary identifier (5G-GUTI), the 5G temporary mobile subscriber identity (5G-TMSI), and the 5G S-temporary mobile subscriber identity (5G-S-TMSI). It is worth mentioning that permanent identifiers do not change during the lifetime of the subscription for a user. Hence, by recognizing a permanent identifier, a user's identity may be revealed. Hence, in order to enhance user privacy, it is desired to protect the user's permanent identifiers by limiting the number of CN components that have access to them. Some 5G identifiers are briefly explained as follows:

### I-B.1) SUPI

Every user in 5G is assigned a globally unique identifier called SUPI, which is a permanent identifier. It is defined in 3GPP 5G specifications and is provisioned in the UDM 50 and in the UDR 55. The SUPI may contain an international mobile subscriber identity (IMSI), which is a unique identifier allocated to users in various systems, such as global system for mobile (GSM), universal mobile telephone system (UMTS) and evolved packet system (EPS). Alternatively, the SUPI may contain a network specific identifier, which takes a network access identifier (NAI) format. In case the SUPI contains an IMSI, it is a 15-digits decimal number, win which the first 3 digits represent the mobile country code (MCC), the next 2 or 3 digits represent the mobile network code (MNC), the last 9 or 10 digits representing the mobile subscription identification number (MSIN) that identifies the mobile subscription within a public land mobile network (PLMN).

### I-B.2) PEI

The PEI, which is a permanent identifier, identifies the mobile equipment itself, i.e. the UE 85. They PEI may indicate an international mobile equipment identity (IMEI) or an IMEI and software version number (IMEISV). Hence, the UE of a user indicates the PEI and its format to the network. In case the PEI indicates an IMEI, it contains an 8-digit type allocation code (TAC) and a 6-digit serial number (SNR). PEI may be used to check whether a given UE is blacklisted or not.

### I-B.3) GPSI

The GPSI is a permanent public identifier that is used inside and outside 3GPP 5G specifications for addressing a 3GPP subscription in different data networks. The GPSI may indicate a mobile subscriber ISDN number (MSISDN) or an external identifier. In case the GPSI indicates an MSISDN, it has a maximum length of 15 digits and is composed of 1 to 3 digits country code (CC), a national destination code (NDC), and a subscriber number (SN) such that the length of NDC+SN is 12 to 14 digits.

### I-C. 5G Trust Model

In cellular networks in general, and in 5G networks in particular, a trust model determines which entities are trusted with sensitive user data. Trust models introduced in fourth generation (4G) LTE networks comprise entities like subscribers (users), mobile equipment (ME—another term for the UE 85), mobile network operators (MNOs), virtual MNOs (VMNOs), service providers, and equipment manufacturers. Conventionally, a user and its UE 85 trust the MNOs, the VMNOs, and the service providers, and generally assume that the terms and conditions in the subscription contracts with the MNOs will be followed properly. The MNOs are responsible for providing network connectivity to the users in a manner that should protect user privacy. However, some vulnerabilities have been reported, in which a user's long term identifier (IMSI) was eavesdropped over the air.

In conventional 5G procedures, a public key encryption mechanism is used to protect the SUPI (the 5G equivalent to the 4G IMSI) over the RAN 80. The UE encrypts SUPI by the MNO's public key to generate the SUCI and sends the encrypted SUCI over the air to the AMF 30. Although, the AMF 30 cannot extract the SUPI from the received SUCI, it relays the SUCI to the UDM 50 and later receives the decrypted version of the SUCI from the UDM 50. Thereafter, the SUPI is transmitted between all the components of the 5G CN 10 in order to identify the user. Hence, in conventional 5G procedures, it is generally assumed that all CN components are trusted and are given access to all permanent user identifiers.

### I-D. 5G Registration Procedure

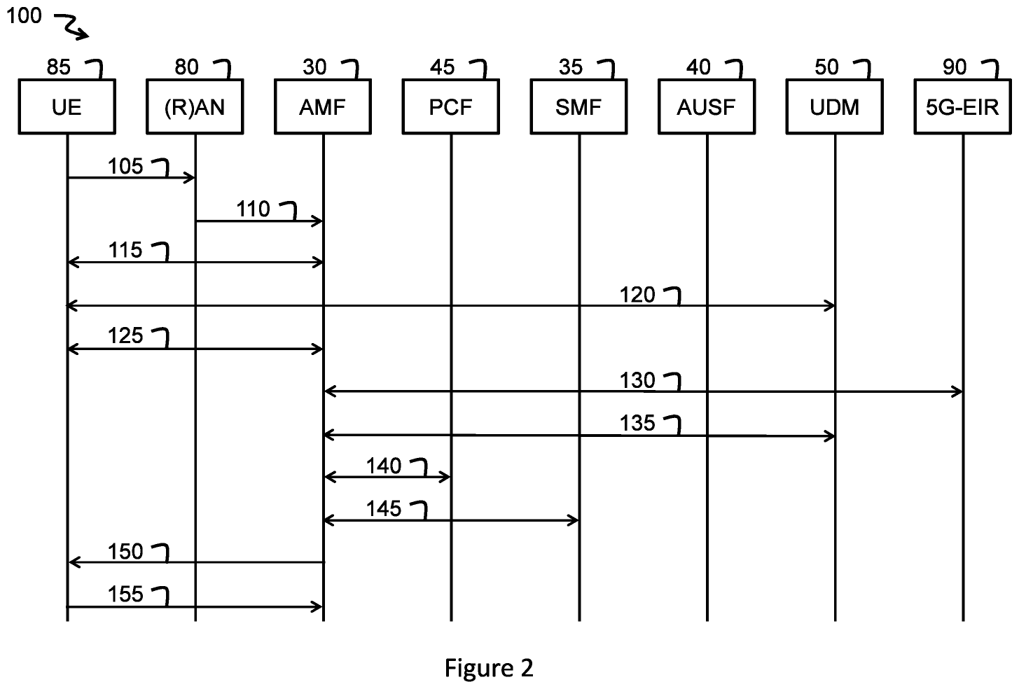

FIG. 2 summarizes the conventional 5G UE registration procedure 100 described in 3GPP 5G specifications. The order of the various operations of the sequence 100 may differ from the illustration of FIG. 2 and some operations may not be present in some embodiments. The 5G UE registration procedure 100 starts at operations 105 and 110 with the UE 85 sending a registration request signal, via an access network (AN), for example and without limitation the RAN 80, to the AMF 30. The registration request signal indicates the registration type. The UE 85 identifies itself by either its SUCI, 5G-GUTI, or PEI. In case the SUCI is not provided by the UE 85, the AMF 30 may obtain the SUCI from the UE 85 at operation 115. At operation 120, selection of the AUSF 40 takes place between the UE 85 and the UDM 50 and an authentication procedure for the UE 85 is performed according to 3GPP 5G specifications. During operation 120, the UDM 50 decrypts the SUCI and sends back the SUPI to the AMF 30. Thereafter, in case the UE 85 has not provided its PEI to the AMF 30, the AMF 30 may obtain the PEI from the UE 85 at operation 125. Using the provided PEI, the AMF 30 then contacts a 5G equipment identity register (EIR) 90 at operation 130 to check the status the PEI, thereby verifying that the UE 85 has not been blacklisted. At operation 135, based on the provided SUPI, the AMF 30 selects the UDM 50, registers therewith, and fetches relevant user subscription data for the UE 85. In this operation 135, the AMF 30 obtains the GPSI for the user. After that, at operation 140, the AMF 30 establishes an access and mobility policy association with the PCF 45, following which the AMF 30 performs a PDU session update with the SMF 35 at operation 145. Finally, the AMF 30 sends a registration accept message to the UE at operation 150, to which the UE responds by sending a registration complete signal at operation 155. At that time, the 5G registration procedure is completed.

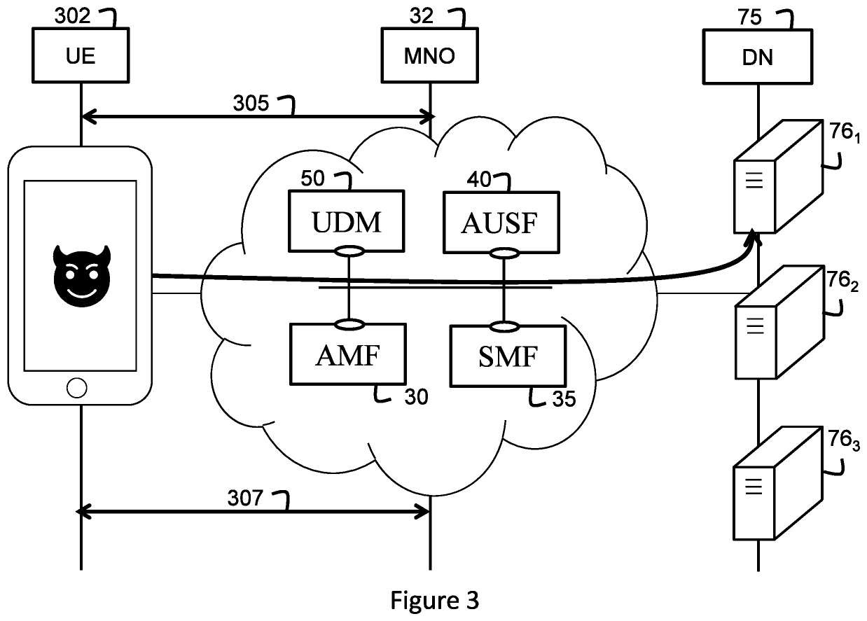

FIG. 3 illustrates a secondary authentication procedure involving a malicious UE 300 and an external DN-AAA server 76₁. At operation 305, it is assumed that the malicious UE 300 has a valid SUPI and thus passes the primary authentication at an MNO 32. At operation 307, the malicious UE 300 requests to establish a PDU session with the external DN 75. The SMF 35 in the MNO 32 verifies that the request of the malicious UE 300 is valid based on its subscription information. The SMF 35 then determines that authentication is required using one of the external DN-AAA server 76ᵢ. The SMF 35 identifies the specific DN-AAA server 76₁ based on the service ID presented by the malicious UE 300. Therefore, the SMF 35 initiates the secondary authentication procedure with the DN-AAA server 76₁ in order to establish the malicious UE 300 requested PDU session. In this process, the SMF 35 relies on the presented service ID by the malicious UE 300 to identify the DN-AAA server 76₁. Hence, the malicious UE 300 may manipulate its presented service ID to make the SMF 35 direct its authentication traffic towards any DN-AAA server 76ᵢ and perform a DDoS attack.

As will be described in greater details herein below, the ZKP-based authentication protocol includes an edge-based authentication protocol that enables MNOs to identify an identity of a UE, said identity being associated with a certain SP, without revealing the UE's credentials (i.e. Service ID or DN-specific identity and secret S) during the secondary authentication procedure or during the primary and secondary authentication procedures. Said ZKP-based authentication protocol may leverage computational resources in the edge of the 5G CN and may effectively prevent DDoS attacks and recognize them before they can cause considerable damages to both the DN-AAA server and the 5G CN.

### II. Partial-Id ZKP Protocol of the Present Technology

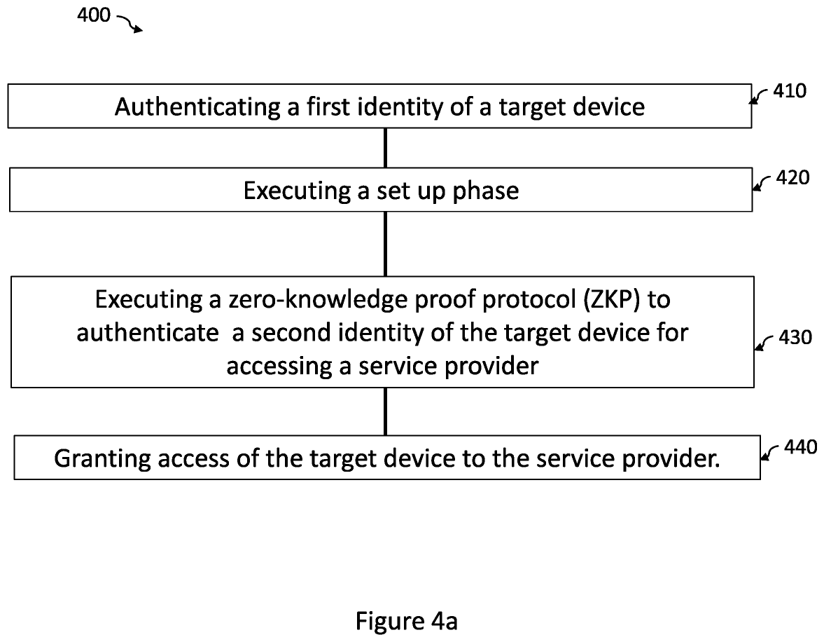

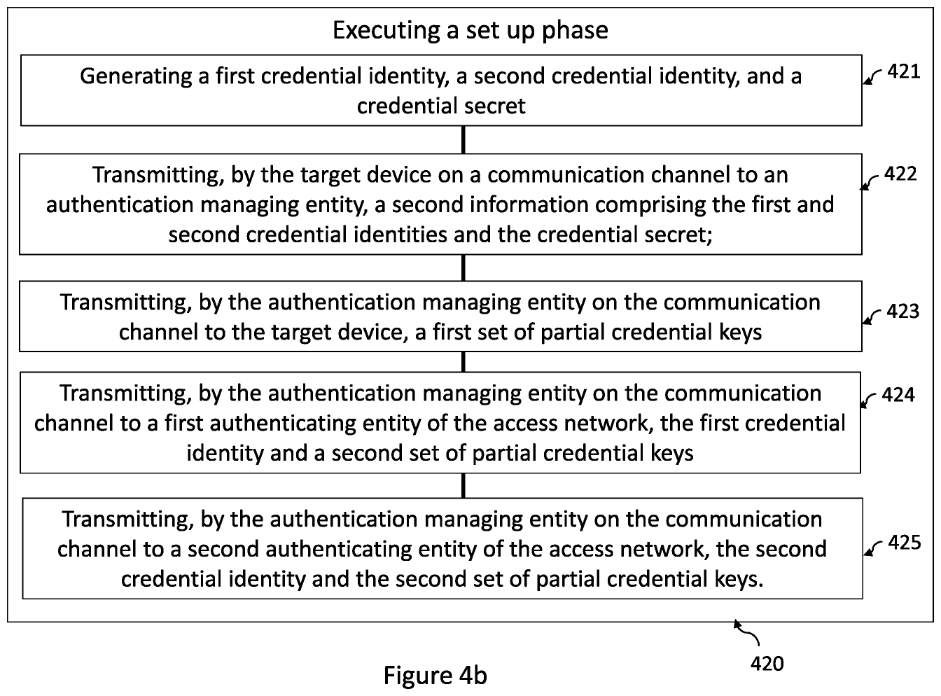

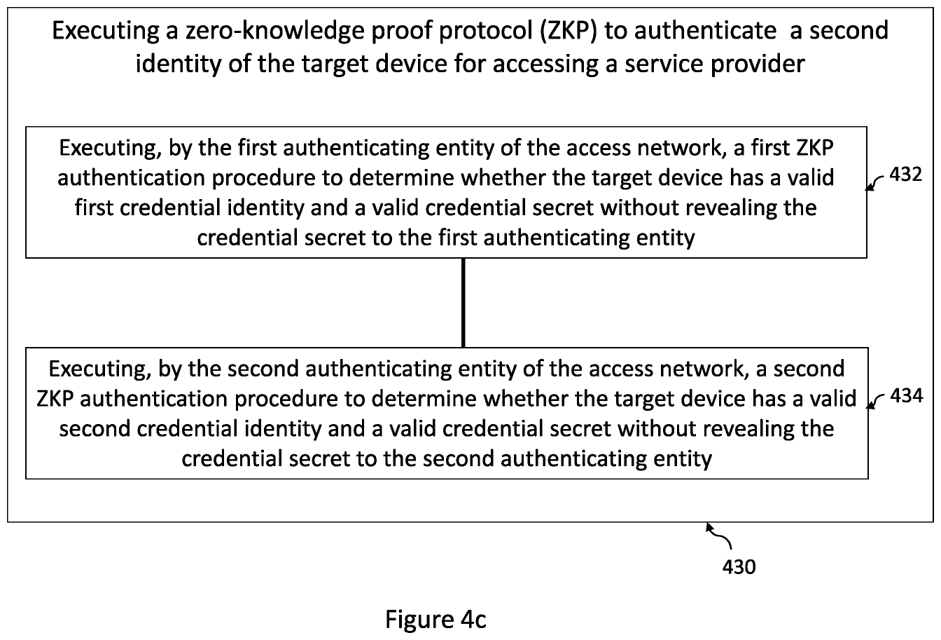

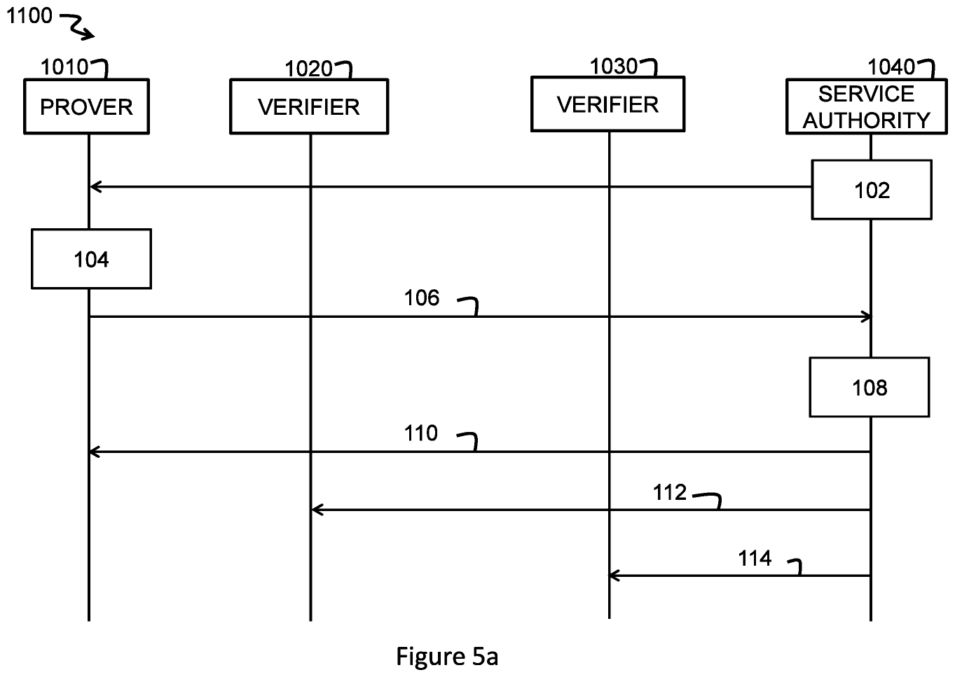

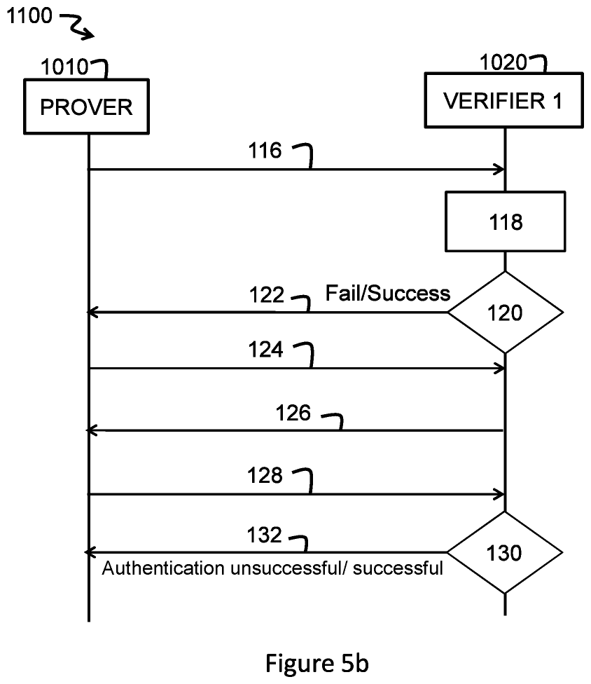

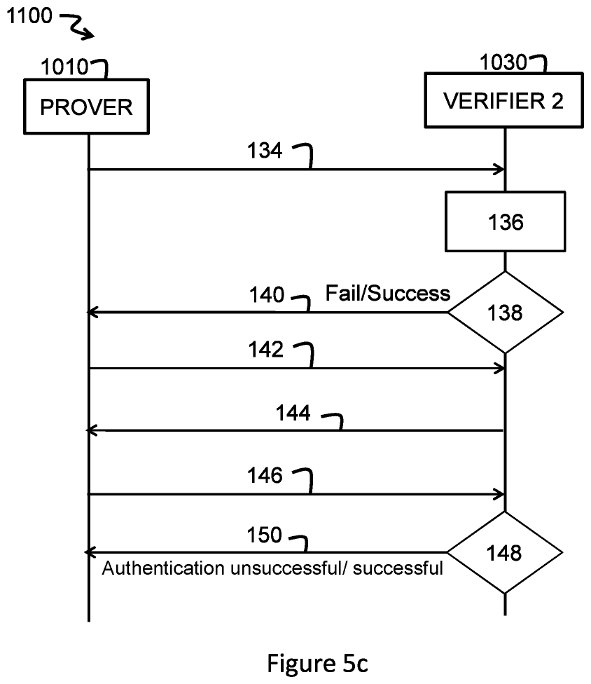

With reference to FIGS. 4a, 4b and 4c, an authentication method 400 for a target device, such as the UE 85, to be granted access to a service provider according to some implementations of the present technology is illustrated in the form of a flowchart. In some implementations, one or more operations of the method 400 could be implemented, in whole or in part, by another computer-implemented device associated with the UE 85. It is also contemplated that the method 400 or one or more operations thereof may be embodied in computer-executable instructions that are stored in a computer-readable medium, such as a non-transitory mass storage device, loaded into memory and executed by a processor. Some operations or portions of operations in the flow diagram may be possibly being executed concurrently, omitted or changed in order. The method 400 involves an execution of zero-knowledge proof (ZKP) procedures. An illustrative and non limiting implementation of the method 400 will be described with reference to FIGS. 5a, 5b and 5c herein below.

Referring to FIG. 4a, the method 400 may begin with authenticating, at operation 410, at an access network, for example a 5G access network, a first identity of the target device for registering on the access network. In one embodiment, authenticating the first identity of the target device is made in response to receiving a registration request from the target device at the access network.

The method 700 may continue with executing, at operation 420, a setup phase. With reference to FIG. 4b, the setup phase begins with, in this embodiment, at sub-operation 421, generating, at the target device, a first credential identity, a second credential identity, and a credential secret, the first and second credential identities and the credential secret being associated with a second identity of the target device for access of the target device to the service provider. The first credential identity and the second credential identity may be generated based on a random selection among a plurality of credential identities.

The setup phase continues with transmitting, by the target device on a communication channel to an authentication managing entity of the service provider at sub-operation 422, a second information comprising the first and second credential identities and the credential secret. For example and without limitation, the authentication managing entity may be a server of the service provider.

The setup phase continues with transmitting, by the authentication managing entity on the communication channel to the target device at sub-operation 423, a first set of partial credential keys, the partial credential keys of the first set of partial credential keys being based on the first and second credential identities and on the credential secret.

The setup phase continues with transmitting, by the authentication managing entity on the communication channel to a first authenticating entity of the access network at sub-operation 424, the first credential identity and a second set of partial credential keys.

The setup phase terminates with transmitting, by the authentication managing entity on the communication channel to a second authenticating entity of the access network at sub-operation 425, the second credential identity and the second set of partial credential keys. It may be noted that the communication channel used in sub-operations 422, 423, 424 and 425 may include the same access network used to perform the authentication of operation 410 or may alternatively consist of a distinct channel. It may also be noted that the setup phase of operation 420 may, in an embodiment, precede the authentication performed at operation 410.

Referring back to FIG. 4a, the method 400 continues with, in response to a successful authentication of the first identity by the access network, executing, at the access network at operation 430, a zero-knowledge proof (ZKP) protocol to authenticate a second identity of the target device for accessing a service provider. In one embodiment, executing the zero-knowledge proof protocol to authenticate the second identity of the target device is made in response to receiving a service request from the target device at the access network. With reference to FIG. 4c, the execution of the ZKP protocol begins with, in this embodiment, at sub-operation 432, executing, by the first authenticating entity of the access network, a first ZKP authentication procedure to determine whether the target device has a valid first credential identity and a valid credential secret without revealing the credential secret to the first authenticating entity. Illustrative first and second ZKP authentication procedures are described herein below. The execution of the ZKP protocol continues with executing, by the second authenticating entity of the access network, at sub-operation 434 and in response to determining, based on a result of the first ZKP authentication procedure, that the target device has a valid first credential identity and a valid credential secret, a second ZKP authentication procedure to determine whether the target device has a valid second credential identity and a valid credential secret without revealing the credential secret to the second authenticating entity.

In one embodiment, executing, by the first authenticating entity of the access network, the first ZKP authentication procedure comprises transmitting, by the target device on the access network to the first authenticating entity, a subset of the first set of partial credential keys. In the same of another embodiment, executing, by the second authenticating entity of the access network, the second ZKP authentication procedure comprises transmitting, by the target device on the access network to the second authenticating entity, a subset of the first set of partial credential keys. An illustrative implementation of the ZKP protocol, referred to as “Partial-ID ZKP protocol”, is described in greater details herein below.

Referring back to FIG. 4a, the method 400 then terminates with granting access of the target device to the service provider by the access network, at operation 440 in response to a successful authentication of the second identity.

FIGS. 5a, 5b and 5c illustrate the partial-identity zero-knowledge-proof (Partial-ID ZKP) authentication procedure 1100. The Partial-ID ZKP authentication procedure 1100 is a NIZKP algorithm that minimizes the number of interactions between a prover 1010 and a verifier.

It should be understood that the following implementation of the Partial-ID ZKP authentication procedure 1100 according to mathematical formulas disclosed below is a mere example of a possible implementation. As such, any procedure variation configured to enable ZKP authentication protocol may be adapted to execute embodiments of the present technology, once teachings presented herein are appreciated. In this embodiment, the Partial-ID ZKP authentication procedure 1100 involves:
the prover 1010: entity which proves its legitimacy to the Verifier, the prover 1010 being associated with two credential identities IDᵥ₁ and IDᵥ₂ that may be randomly selected in this embodiment;
   the verifier: entities that verify that the prover 1010 is legitimate without knowing the secret of the prover 1010. In the Partial-ID ZKP authentication procedure 1100, the verifier comprises two entities: a first authenticating entity 1020 and a second first authenticating entity 1030, also referred to as the first and second authenticating entities 1020, 1030 respectively. As will be described in greater details herein after, a network function having the role of the first authenticating entity 1020 may be located at the edge of the core network. A network function having the role of the second authenticating entity 1030, on the other hand, may be located further inside the core network. Such disposition of the first and second authenticating entities 1020, 1030 may facilitate mitigation DDoS attacks as close as possible to a source of the attack (i.e. at the first authenticating entityl020). Therefore, the prover 1010 may start interacting with the second authenticating entity 1030 if it succeeds in convincing the first authenticating entity 1020 that it is a legitimate entity; and
an authentication managing entity 1040: entity which knows service account credentials of the prover 1010 (e.g., credential identities and secret) for accessing the service provider. For example and without limitation, the service account credential of the prover 1010 may comprise an email address or a login name used by a user of the prover 1010 to access the service provider.

In this embodiment, the Partial-ID ZKP authentication procedure 1100 has two phases; a setup phase and an authentication phase. In the setup phase, the prover 1010 registers its service account credentials with the authentication managing entity 1040. In the authentication phase, the prover 1010 proves to the first and second authenticating entities 1020, 1030 that it has a valid secret. FIG. 5a shows the setup phase of the Partial-ID ZKP authentication procedure 1100 wherein transmission of information between the prover 1010, the authentication managing entity 1040 and the first and second authenticating entities 1020, 1030 is made over a communication channel that may be the access network or be different from the access network. For example and without limitation, the communication channel may be a wired or wireless communication link including 4G, LTE, Wi-Fi, or any other suitable connection.

At operation 102, the authentication managing entity 1040 chooses a prime number n, an office identifier ID*∈ [symbol] ₙ^{*} and a system generator g∈ [symbol] ₙ^{*}−{1}, wherein [symbol] ₙ^{*} denotes all non-zero integer numbers less than n. At this operation, the authentication managing entity 1040 further transmits the prime number n to the prover 1010.

At operation 104, the prover 1010 chooses a secret S∈ [symbol] ₙ^{*}, a first sub-secret S₁ and a second sub-secret S₂, where S₁>S₂ and S₁+S₂=S.

At operation 106, the prover 1010 transmits the secret S, the sub-secret S₂, the first and second credential identities IDᵥ₁ and IDᵥ₂ to the authentication managing entity 1040.

At operation 108, the authentication managing entity 1040 chooses a random number k uniformly from [symbol] ₙ^{*} where k≥5, and a confidence indicator m∈ [symbol] ⁺ where m≤k! and [symbol] ⁺ denotes the set of all positive integers . In this embodiment, the confidence indicator is negatively correlated with a probability of successful authentication of a malicious UE by the Partial-ID ZKP protocol. In other words, by increasing m, a probability of a successful false authentication decreases. The value of m may be chosen in a way to balance the trade-off between a successful authentication probability and computational complexity of the disclosed protocol.

At this operation 108, the authentication managing entity 1040 also forms the polynomial
f(x)=a₀+a₁·x+a₂·x²+ . . . +aₖ₋₁·x^{k-1} where the coefficients a₀, a₁, a₂, . . . , aₖ₋₁ satisfy the following five conditions:
(i) f(0)=IDᵥ₁;
(ii) f(1)=IDᵥ₂;
(iii) f(x^{*})=ID^{*}, for a randomly chosen x^{*}∈ [symbol] ₙ^{*};
(iv) f(IDᵥ₁)=g^{S} mod n, where mod denotes the modulus operator which returns the remainder after a division; and
(v) f(IDᵥ₂)=g^{S-S}^{₂}mod n.

Still at this operation108, the authentication managing entity 1040 chooses different numbers x₁, x₂, . . . , xₖ ∈ [symbol] ₙ^{*}−{x^{*}, 1, IDᵥ₁, IDᵥ₂} randomly and uniformly, and calculates ID₁=f(x₁), ID₂=f(x₂), . . . , IDₖ=f(xₖ).

At operation 110, the authentication managing entity 1040 transmits the first set of partial credential keys comprising (x₁, ID₁), (x₂, ID₂), . . . , (xₖ, IDₖ), and m to the prover 1010. As such, the partial credential keys of the first set of partial credential keys are based on the first and second credential identities and on the credential secret.

At operation 112, the authentication managing entity 1040 transmits a second set of partial credential keys constituted of (x^{*}, ID^{*}), m, n and g, and the first credential identity IDᵥ₁ to the first authenticating entity 1020.

At operation 114, the authentication managing entity 1040 transmits a second set of partial credential keys constituted of (x^{*}, ID^{*}), m, n and g, and the second credential identity IDᵥ₂ to the second authenticating entity 1030.

FIGS. 5b and 5c show the authentication phase of the Partial-ID ZKP authentication procedure 1100. With reference to FIG. 5b, the first authenticating entity 1020 executes a first ZKP authentication procedure to determine whether the target device has a valid first credential identity and a valid credential secret without revealing the credential secret to the first authenticating entity. At operation 116, the prover 1010 sends a subset of the first set of partial credential keys to the first authenticating entity 1020, the subset being constituted of (x₁, ID₁), (x₂, ID₂), . . . , (xₖ₋₁, IDₖ₋₁). The first authenticating entity 1020 may not reconstruct the identifier IDᵥ₁ as it only receives k−1 pairs of (xᵢ, IDᵢ) and the polynomial f(.) comprises k coefficient unknown by the first authenticating entity 1020. The first authenticating entity 1020 thus cannot calculate f(0)=IDᵥ₁.

At operation 118, the first authenticating entity 1020 uses the k−1 pairs of (xᵢ, IDᵢ) and (x^{*}, ID^{*}) to determine the polynomial:

f(x)=b₀+b₁·x+b₂·x²+ . . . +bₖ₋₁·x^{k-1}.

More specifically, the coefficients bᵢ (i∈[0,k−1]) may be determined based on a polynomial interpolation method. At this operation, the first authenticating entity 1020 also generates the polynomial:

f^{R}ᵥ₁(x)=round(b₀)+round(b₁)·x+round(b₂)·x²+ . . . +round(bₖ₋₁)·x^{k-1},

where round(.) denotes the rounding operation to the nearest integer.

At operation 120, the first authenticating entity 1020 determines whether round(fᵥ₁(0)) equals IDᵥ₁ or not. If not, the authentication fails at this operation and the prover 1010 is rejected.

At operation 122, the first authenticating entity 1020 transmits a signal to the prover 1010 indicative of a success or a failure of operation 120. In other words, if round(fᵥ₁(0)) equals IDᵥ₁, the authentication phase of the Partial-ID ZKP authentication procedure 1100 proceeds with the following operations.

At operation 124, the prover 1010 chooses m different numbers rᵢ randomly and uniformly from [symbol] ₙ^{*}, where i∈{ 1, . . . , m}. As such, gcd(rᵢ, n) equals 1, where gcd(x,y) is the greatest common divisor operator for the two integers x and y. The prover 1010 chooses m random permutations πᵢ on {0, 1, 2, . . . , k−1}. The Prover then calculates Bᵢ=g^{r}^{ᵢ}mod n. As such, different Bᵢ for different values of i may have the same value. If determination is made that two Bᵢ for different values of i have the same value, another random value rᵢ is used such that: ∀i, ∀j≠i, Bᵢ≠Bⱼ. The prover 1010 further sends (Bᵢ, πᵢ) for i∈[1,m] to the first authenticating entity 1020.

At operation 126, the first authenticating entity 1020 chooses a random vector c=(c₁, c₂, . . . , cₘ)∈{0,1}^{m} and sends the random vector c to the prover 1010.

At operation 128, the prover 1010 determines a polynomial:

f(x)=d₀+d₁·x+d₂·x²+ . . . +dₖ₋₁·x^{k-1} using the k pairs of (xᵢ, IDᵢ).

At this operation, the prover 1010 also generates the polynomial:

f^{R}_{P}(x)=round(d₀)+round(d₁)·x+round(d₂)·x²+ . . . +round(dₖ₋₁)·x^{k-1}.

Also at operation 128, the prover 1010 determines Aᵢ=f^{R}_{P},πᵢ(rᵢ) for each cᵢ=0 of the vector c, where f^{R}_{P},πᵢ(x) is a polynomial which is generated by applying the permutation πᵢ on the coefficient of the polynomial f^{R}ₚ(x). Otherwise, for each c_{ib =1,} the prover 1010 determines Aᵢ=(rᵢ−S) mod (n−1). The prover 1010 further sends {A₁, A₂, . . . , Aₘ} to the first authenticating entity 1020.

At operation 130, the first authenticating entity 1020 assesses whether the authentication of the prover 1010 by the first authenticating entity 1020 is successful by determining, whether, for each i∈{1, . . . , m}, Bᵢ equals

$${g}^{{( {f}_{V 1 , {π}_{i}}^{R} )}^{- 1} ( {A}_{i} )} mod n$$

if cᵢ=0, and g^{A}^{ᵢ}·round(fᵥ₁(IDᵥ₁)) mod n if cᵢ=1. In other words:

$${Authentication}_{i}^{Verifier 1} = ( {B}_{i} == ( {g}^{{( {f}_{V 1 , {π}_{i}}^{R} )}^{- 1} ( {A}_{i} )} mod n ) ) if {c}_{i} = 0 ; \qquad ( 1 )$$

$${Authentication}_{i}^{Verifier 1} = ( {B}_{i} == ( {g}^{{A}_{i}} . round ( {f}_{V 1} ( {ID}_{V 1} ) ) mod n ) ) if {c}_{i} = 1 \qquad ( 2 )$$

where “==” is the equal-to operator which returns true if both operands have the same value and false otherwise.

If the above statements hold (i.e. ∀i, Authenticationᵢ^{Verifier 1}=true), then the authentication of the prover 1010 by the first authenticating entity 1020 is successful with a probability of 1-2^{m}. A signal indicative of a failure of success of operation 130 may be transmitted by the first authenticating entity 1020 to the prover 1010 at operation 132. If determination is made that the authentication of the prover 1010 by the first authenticating entity 1020 is successful, the second authenticating entity 1030 executes a second ZKP authentication procedure to determine whether the prover 1010 has a valid second credential identity and a valid credential secret without revealing the credential secret to the second authenticating entity 1030. With reference to FIG. 5c, at operation 134, the prover 1010 transmits a subset of the first set of partial credential keys to the second authenticating entity 1030, the sub-set being constituted of (x₁, ID₁), (x₂, ID₂), . . . , (xₖ₋₁, IDₖ₋₁).

At operation 136, the second authenticating entity 1030 determines polynomial:

fᵥ₂(x)=b′₀+b′₁·x+b′₂·x²+ . . . b′ₖ₋₁·x^{k-1}

using the k−1 pairs of (xᵢ, IDᵢ) and (x^{*}, ID^{*}). More specifically, the coefficients bᵢ (i∈[0,k−1]) may be determined based on a polynomial interpolation method. At this operation, the second authenticating entity 1030 also generates the polynomial:

f^{R}ᵥ₂(x)=round(b′₀)+round(b′₁)·x+round(b′₂)·x²+ . . . +round(b′ₖ₋₁)·x^{k-1}.

At operation 138, the second authenticating entity 1030 determines whether round(fᵥ₂(1)) equals IDᵥ₂ or not. If not, the authentication fails at this operation and the prover 1010 is rejected by the second authenticating entity 1030.

At operation 140, the second authenticating entity 1030 transmits a signal to the prover 1010 indicative of a success or a failure of operation 138. In other words, if round(fᵥ₂(1)) equals IDᵥ₂, the authentication phase of the Partial-ID ZKP authentication procedure 1100 proceeds with the following operations.

At operation 142, the prover 1010 chooses m different numbers r′ᵢ, randomly and uniformly from [symbol] ₙ^{*}, where i∈{1, . . . , m}. As such, gcd(r′ᵢ, n) equals 1. The prover 1010 also chooses m random permutations π′ᵢ on {0, 1, 2, . . . , k−1}. The prover 1010 then calculates B′ᵢ=g^{r′}^{ᵢ} mod n. As such, different B′ᵢ for different values of i may have the same value. If determination is made that two Bᵢ for different values of i have the same value, another random value r′ᵢ is used such that: ∀i, ∀j≠i, Bᵢ≠Bⱼ. The prover 1010 further sends (B′ᵢ, π′ᵢ) for i∈[1,m] to the second authenticating entity 1030.

At operation 144, the second authenticating entity 1030 chooses a random vector c′=(c′₁, c′₂, . . . , c′ₘ)∈{0,1}^{m} and sends the vector c′ to the prover 1010.

At operation 146, the prover 1010 determines A′ᵢ=f^{R}_{P},π′ᵢ (r′ᵢ) for each c′ᵢ=0 of the vector c, where f^{R}_{P},π′ᵢ (x) is a polynomial which is generated by applying the permutation π′ᵢ on the coefficient of the polynomial f^{R}ₚ(x). Otherwise, for each c′ᵢ=1, the prover 1010 determines A′ᵢ=(r′ᵢ−(S−S₂)) mod (n−1).

Also at operation 146, the prover 1010 sends {A′₁, A′₂, . . . , A′ₘ} to the second authenticating entity 1030.

At operation 148, the second authenticating entity 1030 assesses whether the authentication of the prover 1010 by the second authenticating entity 1030 is successful by determining, whether, for each i∈{1, . . . , m}, B′ᵢ equals

$${g}^{{( {f}_{V 1 , {π}_{i}^{′}}^{R} )}^{- 1} ( {A}_{i}^{′} )} mod n if {c}_{i}^{′} = 0 ,$$

and g^{A′}^{ᵢ}·round(fᵥ₂(IDᵥ₂)) mod n if c′ᵢ=1. In other words:

$${Authentication}_{i}^{Verifier 2} = ( {B}_{i}^{′} == ( {g}^{{( {f}_{V 2 , {π}_{i}^{′}}^{R} )}^{- 1} ( {A}_{i}^{′} )} mod n ) ) if {c}_{i}^{′} = 0 ; \qquad ( 3 )$$

$${Authentication}_{i}^{Verifier 2} = ( {B}_{i}^{′} == ( {g}^{{A}_{i}^{′}} . round ( {f}_{V 2} ( {ID}_{V 2} ) ) mod n ) ) if {c}_{i}^{′} = 1 \qquad ( 4 )$$

If the above statements hold (i.e. ∀i, Authenticationᵢ^{Verifier 2}=true), then the authentication of the prover 1010 by the second authenticating entity 1030 is successful with a probability of 1-2^{m}. A signal indicative of a failure or success of operation 148 may be transmitted by the second authenticating entity 1030 to the prover 1010 at operation 150. If determination is made that the authentication of the prover 1010 by the second authenticating entity 1030 is successful, then authentication of the prover 1010 is successful according to the Partial-ID ZKP protocol.

The operations 102 to 150 described hereinabove provide completeness and soundness to the Partial-ID ZKP authentication procedure 1100. More specifically, if the prover 1010, the first authenticating entity 1020 and the second authenticating entity 1030 are honest (i.e. unbiased), the prover 1010 is successfully authenticated, which provide completeness. As a demonstration, if cᵢ=0, the prover 1010 knows Aᵢ=f^{R}_{P},πᵢ(rᵢ). Also, f^{R}ᵥ₁,πᵢ(x)=f^{R}_{P},πᵢ(x). Therefore, rᵢ=(f^{R}ᵥ₁,πᵢ)⁻¹(Aᵢ). Hence,

$${g}^{{( {f}_{V 1 , {π}_{i}}^{R} )}^{- 1} ( {A}_{i} )} mod n = {g}^{{r}_{i}} mod n = {B}_{i} . \qquad ( 5 )$$

Similarly, if cᵢ=1, the prover 1010 knows Aᵢ=(rᵢ−S) mod (n−1). Therefore,

$${g}^{{A}_{i}} . round ( {f}_{V 1} . {ID}_{V 1} ) ) mod n = ( {g}^{( {r}_{i} - S ) mod ( n - 1 )} . ( {g}^{S} mod n ) ) mod n = ( ( {g}^{( {r}_{i} - S ) mod ( n - 1 )} mod n ) ( {g}^{S} mod n ) ) mod n \qquad ( 6 )$$

Based on Fermat's Little Theorem:

$$\begin{matrix}{g}^{{A}_{i}} . round ( {f}_{V 1} ( {ID}_{V 1} ) ) mod n = ( ( {g}^{( {r}_{i} - S )} mod n ) . ( {g}^{S} mod n ) ) mod n \\ = ( {g}^{( {r}_{i} - S + S )} mod n ) mod n \\ = ( {g}^{{r}_{i}} mod n ) mod n \\ = {B}_{i}\end{matrix} \qquad ( 7 )$$

Additionally, if a prover is illegitimate (i.e. wishes to use the secret and credential identities of the prover 1010), it cannot convince either of the first authenticating entity 1020 and the second authenticating entity 1030. Since only k−1 pairs are transmitted over the communication network during the authentication phase, the illegitimate prover cannot reconstruct the polynomial fₚ(x) of the legitimate prover 1010. Therefore, the illegitimate prover will fail at operation 120 (FIG. 5b). Moreover, the problem of finding S from g^{S} mod n is an NP-hard problem. Hence, the illegitimate prover cannot retrieve S in a polynomial time.

Moreover, for each cᵢ=0, the illegitimate prover cannot learn Aᵢ because it does not know the polynomial fₚ(x) of the legitimate prover 1010. Therefore, the illegitimate prover cannot send a correct Aᵢ which satisfies equation (1). For each cᵢ=1, the illegitimate prover does not know S and also cannot learn S from Aᵢ=(rᵢ−S) mod (n−1).Therefore, the illegitimate prover cannot find Aᵢ which satisfies Bᵢ=g^{A}^{ᵢ}·round(fᵥ₁(IDᵥ₁)) mod n at operation 130. This means the illegitimate prover cannot convince the first authenticating entity 1020. Therefore, the soundness property is satisfied.

In the disclosed Partial-ID ZKP authentication procedure 1100, repeating the authentication procedure does not reveal any information about the prover 1010, except for the fact that it has a valid secret. In other words, the first authenticating entity 1020 and the second authenticating entity 1030 do not learn anything about secret of the prover 1010 by repeating the above-mentioned authentication procedure.

### III. EAP-ZKP Protocol of the Present Technology in the 5G Framework

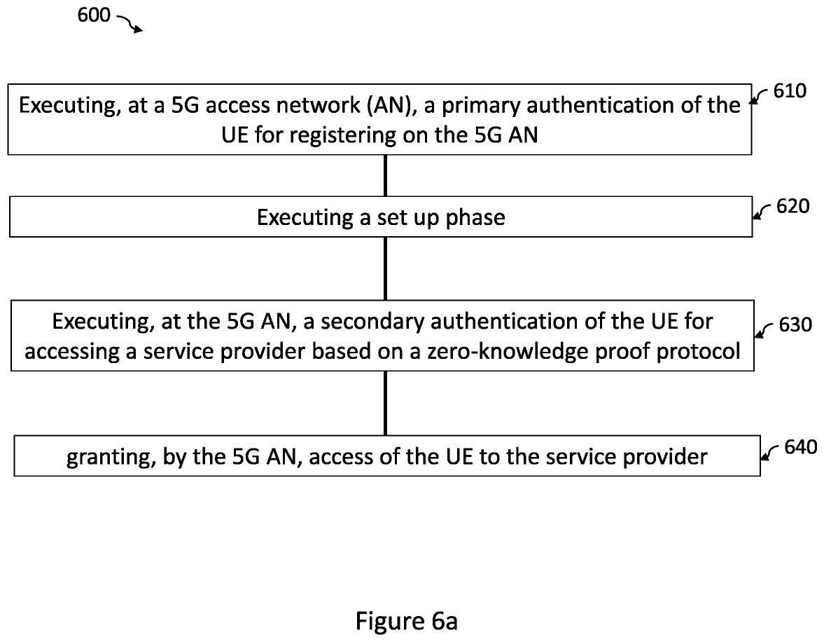

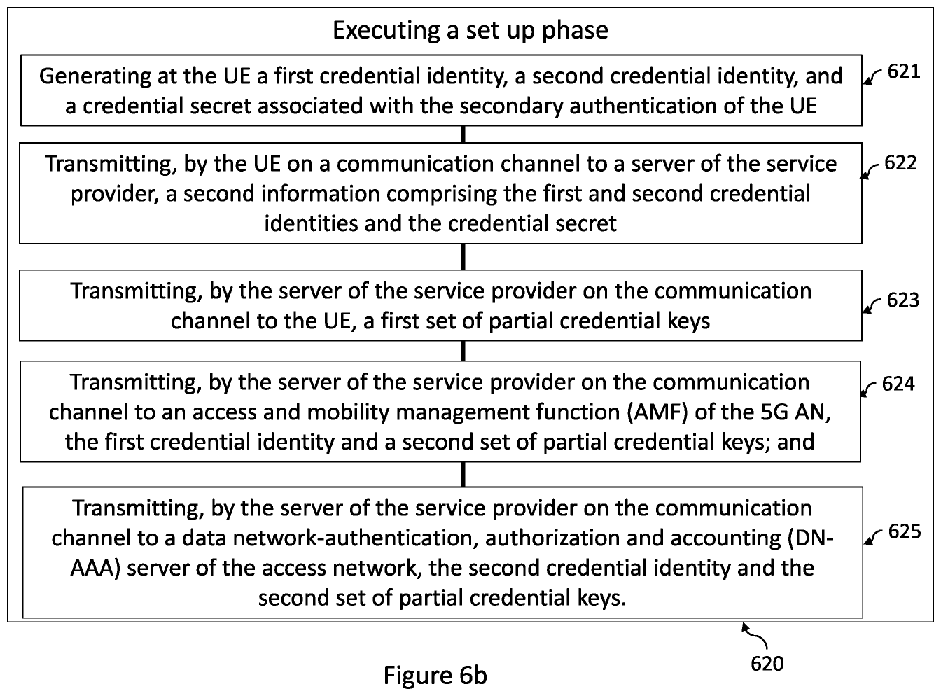

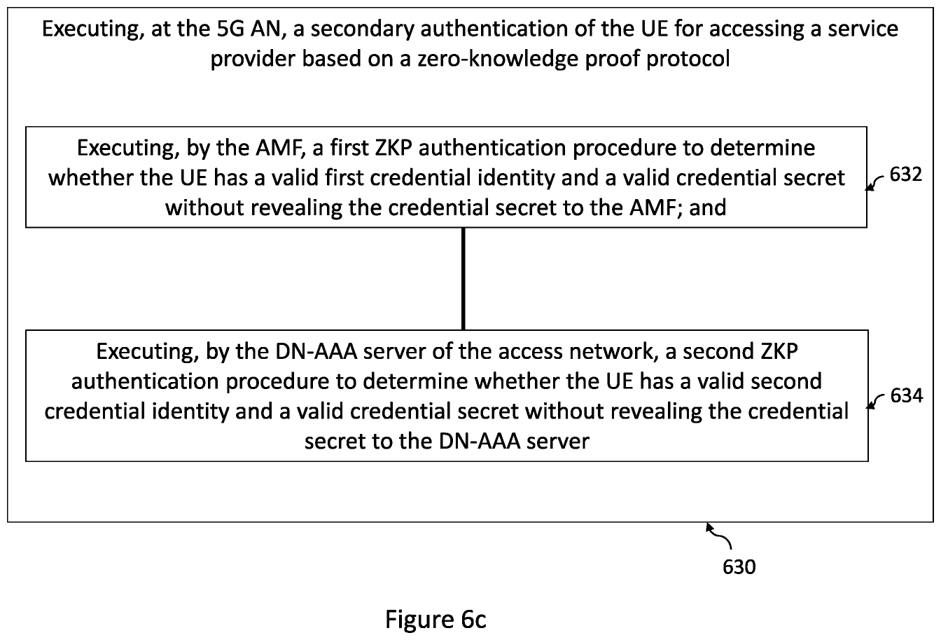

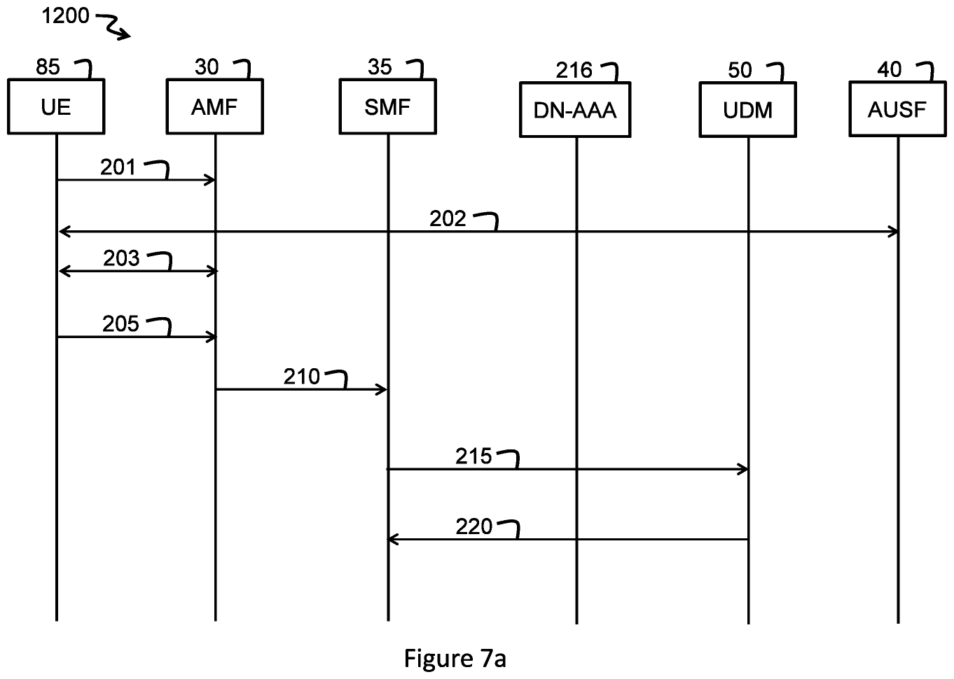

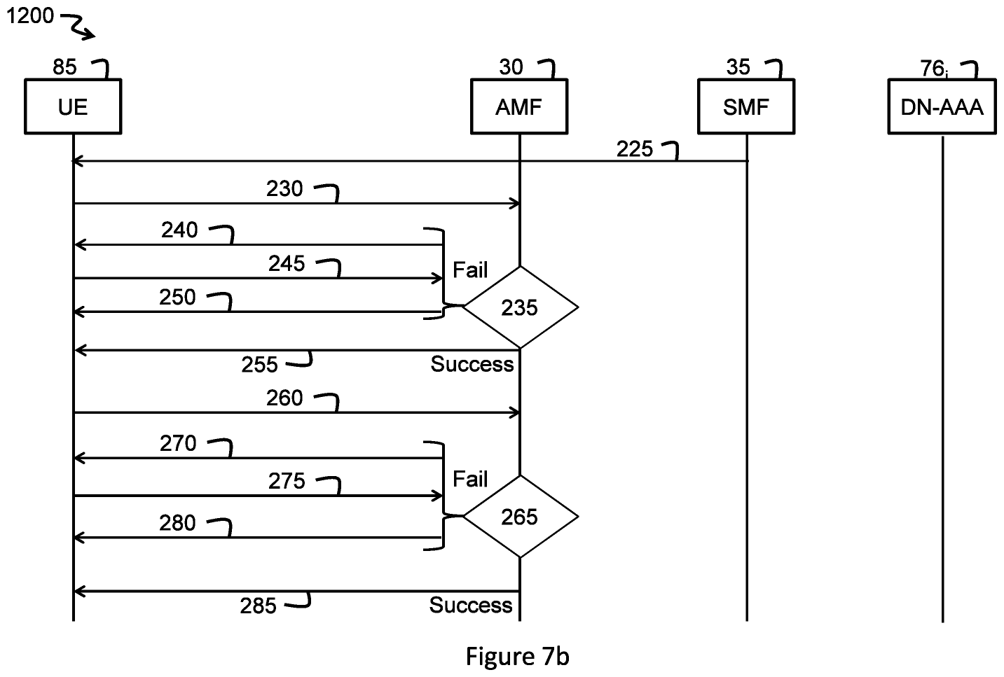

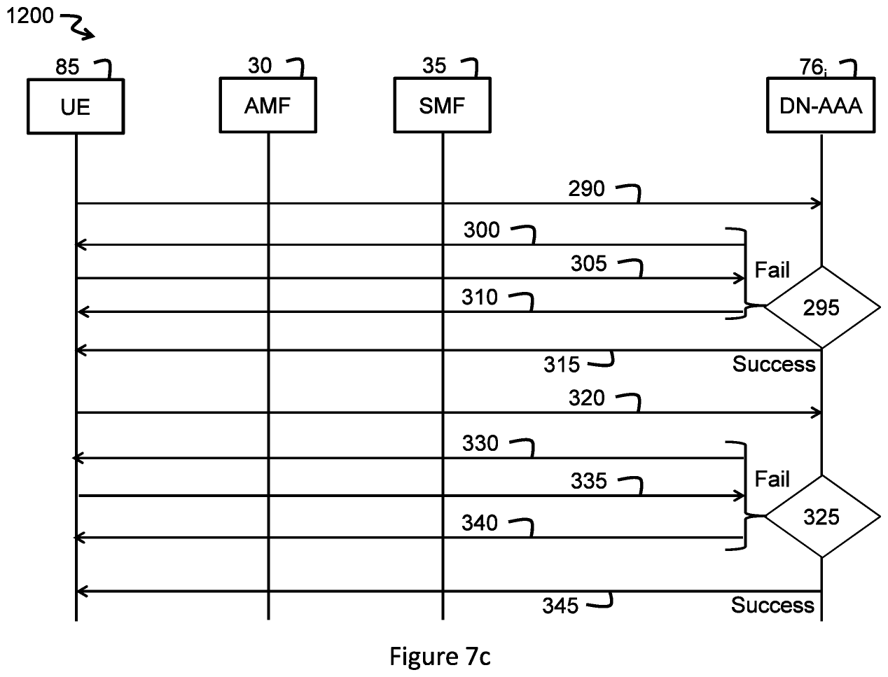

An implementation of the Partial-ID ZKP authentication procedure 1100 in the 5G framework according to non-limiting embodiments of the present technology is introduced with respect to FIGS. 6a to 7b. In this implementation, the UE 85 plays the role of the target device, the AMF 30 plays the role of the first authenticating entity 1020 and the DN-AAA server 216 plays the role of the second authenticating entity 1030.

With reference to FIGS. 6a, 6b and 6c, an authentication method 600 for the user equipment (UE) 85 communicably connected to a 5G access network (AN) according to some implementations of the present technology is illustrated in the form of a flowchart. In some implementations, one or more operations of the method 600 could be implemented, whole or in part, by another computer-implemented device associated with the UE 85. It is also contemplated that the method 600 or one or more operation thereof may be embodied in computer-executable instructions that are stored in a computer-readable medium, such as a non-transitory mass storage device, loaded into memory and executed by a processor. Some operations or portions of operations in the flow diagram may be possibly being executed concurrently, omitted or changed in order.

The method 600 may begin with executing, at operation 610, at the 5G AN, a primary authentication of the UE 85 for registering on the 5G AN. In one embodiment, the primary authentication is executed by the authentication server function (AUSF) 40 of the 5G AN based on a protocol such as fifth generation authentication and key agreement (5G AKA) protocol and improved extensible authentication protocol-authentication and key agreement (EAP-AKA′) protocol. In one embodiment, the primary authentication is executed in response to receiving a registration request the UE 85 at the 5G AN.

The method 600 may continue with executing, at the 5G AN, at operation 620, a setup phase. With reference to FIG. 6b, the setup phase begins with, in this embodiment, at sub-operation 621, generating, at the UE 85, a first credential identity, a second credential identity, and a credential secret, the first and second credential identities and the credential secret being associated with the second identity of the UE 85 for access of the UE 85 to the service provider. In this embodiment, described hereinabove, the first credential identity is a 5G subscription permanent identifier (SUPI) of the UE 85. The second credential identity is a service provider user identifier (SP user ID, or “Service ID”) of the UE 85.

The setup phase continues with transmitting, by the UE 85 on a communication channel to a server of the service provider at sub-operation 622, a second information comprising the first and second credential identities and the credential secret.

The setup phase continues with transmitting, by the server of the service provider on the communication channel to the UE 85 at sub-operation 623, a first set of partial credential keys, the partial credential keys of the first set of partial credential keys being based on the first and second credential identities and on the credential secret.

The setup phase continues with transmitting, by the server of the service provider on the communication channel to the access and mobility management function (AMF) 30 of the 5G AN at sub-operation 624, the first credential identity and a second set of partial credential keys.

The setup phase terminates with transmitting, by the server of the service provider on the communication channel to the data network-authentication, authorization and accounting (DN-AAA) server 76ᵢ of the access network at sub-operation 625, the second credential identity and the second set of partial credential keys. It may be noted that the communication channel used in sub-operations 622, 623, 624 and 625 may include the 5G AN or may alternatively consist of a distinct channel. It may also be noted that the set up phase of operation 620 may, in an embodiment, precede the primary authentication performed at operation 610.

Referring back to FIG. 6a, the method 600 continues with executing, at the 5G AN, at operation 630, in response to a successful primary authentication of the UE 85, a secondary authentication of the UE for accessing a service provider based on a extensible authentication zero-knowledge proof (EAP-ZKP) protocol. In one embodiment, executing the zero-knowledge proof protocol to authenticate the second identity of the UE 85 is made in response to receiving a service request, for example a PDU session establishment request, from the UE 85 at the 5G AN. With reference to FIG. 6c, the execution of the EAP-ZKP protocol begins with, in this embodiment, executing by the AMF 30, at sub-operation 632, a first ZKP authentication procedure to determine whether the UE 85 has a valid first credential identity and a valid credential secret without revealing the credential secret to the AMF 30. As such, the AMF 30 may be referred to as a “Network Guardian”. Indeed, the UE 85 may communicate with other network functions of the 5G AN upon a successful first ZKP authentication procedure by the AMF 30.

The execution of the EAP-ZKP protocol continues with executing by the DN-AAA server 76ᵢ, at sub-operation 634 and in response to determining, based on a result of the first ZKP authentication procedure, that the UE has a valid first credential identity and a valid credential secret, a second ZKP authentication procedure to determine whether the UE 85 has a valid second credential identity and a valid credential secret without revealing the credential secret to the DN-AAA server 76ᵢ.

In one embodiment, the operation 630 further comprises transmitting an identity request from the session management function (SMF) 35 to the UE 85.

Referring back to FIG. 6a, the method 600 terminates with granting by the 5G AN, at operation 640 and in response to a successful secondary authentication, access of the UE 85 to the service provider. In one embodiment, the operation 640 further comprises receiving at the SMF 35, a signal indicative of a success of an execution of the EAP-ZKP protocol.

### IV. Implementation of the EAP-ZKP Protocol in the 5G Framework

FIGS. 7a, 7b and 7c show an illustrative and non-limiting implementation of the first and second ZKP authentication procedures of the EAP-ZKP protocol. It should be understood that a setup phase of the UE 85 already occurred, and that the UE 85 has already undergone the primary authentication and is registered with the 5G network. As such, the first set of partial credential keys determined as described herein above with respect to FIGS. 5a to 5c has already been transmitted to the UE 85. Similarly, the first credential identity and the second set of partial credential keys have been transmitted to the AMF 30 and the second credential identity and the second set of partial credential keys have been transmitted to the DN-AAA server 76ᵢ.

More specifically, FIG. 7a shows illustrative procedures preceding the first and second ZKP authentication procedures. The UE 85 sends a registration request to AMF 30 at operation 201. At operation 202, the UE 85 performs primary authentication with the AUSF 40 based on its network access credentials. Then, UE 85 establishes a non-access stratum (NAS) security context with AMF 30 as indicated at operation 203.

At operation 205, the UE 85 sends a service request for establishing a new packet data unit (PDU) session to the AMF 30. Said request may be a session management (SM) non-access stratum (NAS) message containing a PDU session establishment request. The service request may further comprise identification of a packet data network (PDN) to which the UE 85 requires to be connected. For example, the identification of the PDN may be a data network name (DNN).

At operation 210, the AMF 30 sends a Nsmf-PDUSession-CreateSMContext request signal to the SMF 35, said signal comprising:
a subscription permanent identifier (SUPI) (i.e. a globally unique permanent identifier associated with the UE 85);
a PDU Session ID (i.e. an identifier for the requested PDU session which is set by the UE 85);
and the DNN.

At operation 215, the SMF 35 sends a request to the unified data management (UDM) to receive, at operation 220, the subscription data of the UE 85 which the SMF 35 uses to determine whether the request of the UE 85 is compliant with the user subscription and with local policies.

With reference to FIG. 7b, the AMF 30 then executes the first ZKP authentication procedure according to the following operations. The first ZKP authentication procedure begins with determining, by the SMF 35, at operation 225, that it needs to perform a secondary authentication by the external DN-AAA server 76ᵢ in order to approve the service request of the UE 85 for an establishment of the new packet data unit (PDU) session. At this operation 225, the SMF 35 transmits an EAP Request/Identity signal to the UE 85.

The first ZKP authentication procedure continues with transmitting, by the UE 85 at operation 230, an EAP Response/Identity signal to the AMF 30, said signal comprising the subset of the first set of partial credential keys, the subset being constituting of subset comprising (x₁, ID₁), (x₂, ID₂), . . . , (xₖ₋₁, IDₖ₋₁), and the m pairs of (Bᵢ, πᵢ).

The first ZKP authentication procedure continues with determining, by the AMF 30 at operation 235, whether round(fᵥ₁(0))=SUPI. If not, the AMF 30 transmits a ZKP-Alert message identifying the reason for the failed authentication at operation 240. In response to the ZKP-Alert message, the UE 85 transmits an EAP-Response signal to the AMF 30 at operation 245, the latter transmitting an EAP-Failure message to the UE 85 indicative of a failure of the first ZKP authentication procedure at operation 250.

If round(fᵥ₁(0)) equals SUPI, the AMF 30, acting as the “Network Guardian”, transmits a Network-Guardian-Hello message and the vector c as defined herein above to the UE 85 at operation 255.

The first ZKP authentication procedure continues with transmitting, by the UE 85 to the AMF 30 at operation 260, a response vector a=(Aᵢ)_{i=1, . . . , m} with Aᵢ being defined herein above.

The first ZKP authentication procedure continues with determining, by the AMF 30 at operation 265, whether ∀i, Authenticationᵢ^{Verifier 1}=true. If not, the authentication of the UE 85 fails at this operation 265. As such, the AMF 30 may transmit a ZKP-Alert message identifying the reason for the failed authentication at operation 270. In response to the ZKP-Alert message, the UE 85 transmits an EAP-Response signal to the AMF30 at operation 275, the latter transmitting an EAP-Failure message to the UE 85 indicative of a failure of the first ZKP authentication procedure at operation 280. Otherwise, the AMF 30 may transmit an EAP-Success signal to the UE 85 at operation 285 indicating that the AMF 30 determined that the UE 85 is legitimate and possesses a valid secret.

In this embodiment, the EAP-ZKP protocol continues with the second ZKP authentication procedure between the UE 85 and the DN-AAA server 76ᵢ. However, authentication of the UE 85 by the DN-AAA server 76ᵢ may be executed based on different authentication method such as EAP-TLS protocol, and EAP-TTLS protocol. The UE 85 proved to the AMF 30 that it possesses valid credentials for proceeding with authentication with the DN-AAA server 76ᵢ with the first ZKP authentication procedure. As such, in this embodiment, the AMF 30 may allow the UE to execute a single authentication attempt with the DN-AAA server 76ᵢ. Therefore, if the UE 85 tries to submit fake authentication credentials to the DN-AAA server 76ᵢ in order to perform a DDoS attack for example, the authentication attempt will fail. Hence, the UE 85 may have to restart the first ZKP authentication procedure from the beginning

With reference to FIG. 7c and in case of a successful authentication of the UE 85 by the AMF 30, the second ZKP authentication procedure begins with transmitting, by the UE 85 at operation 290, an EAP Response/Identity signal to the DN-AAA server 76ᵢ, said signal comprising the subset of the first set of partial credential keys, the subset being constituted of (x₁, ID₁), (x₂, ID₂), . . . , (xₖ₋₁, IDₖ₋₁), and the m pairs of (B′ᵢ, π′ᵢ).

The second ZKP authentication procedure continues with determining, by the DN-AAA server 76ᵢ at operation 295, whether round(fᵥ₂(1))=Service ID. If not, the DN-AAA server 76ᵢ transmits a ZKP-Alert message identifying the reason for the failed authentication at operation 300. In response to the ZKP-Alert message, the UE 85 transmits an EAP-Response signal to the DN-AAA server 76ᵢ at operation 305, the latter transmitting an EAP-Failure message to the UE 85 indicative of a failure of the second ZKP authentication procedure at operation 310.

Otherwise, if round(fᵥ₂(1))=Service ID, the DN-AAA server 76ᵢ transmits an EAP Request signal carrying an EAP-Server-Hello message and a challenge vector c′ to the UE 85 at operation 315.

The second ZKP authentication procedure continues with transmitting, by the UE 85 to the DN-AAA server 76ᵢ at operation 320, a response vector a′=(A′ᵢ)_{i=1, . . . , m} with A′ᵢ being defined herein above.

The second ZKP authentication procedure continues with determining, by the DN-AAA server 76ᵢ at operation 325, whether ∀i, Authenticationᵢ^{Verifier 2}=true. If not, the authentication of the UE 85 fails at this operation. As such, the DN-AAA server 76ᵢ may transmit a ZKP-Alert message identifying the reason for the failed authentication at operation 330. In response to the ZKP-Alert message, the UE 85 transmits an EAP-Response signal to the DN-AAA server 76ᵢ at operation 335, the latter transmitting an EAP-Failure message to the UE 85 indicative of a failure of the second ZKP authentication procedure at operation 340. Otherwise, the DN-AAA server 76ᵢ may transmit an EAP-Success signal to the SMF 35 operation 345 indicating that the DN-AAA server 76ᵢ determined that the UE 85 is legitimate and possesses a valid secret. The execution of the EAP-ZKP protocol successfully ends when the first and second ZKP authentication procedures are successful. The SMF 35 may further proceed with a PDU Session Establishment procedure to grant access of the UE 85 to the service provider. More specifically, the SMF 35 may transmit a Nsmf-PDUSession-CreateSMContext response signal to the AMF 30 with EAP-Success message. The AMF 30 may then forward a signal indicative of a granting of the PDU Session establishment to the UE 85, said signal comprising an EAP-Success message.

It will be appreciated that at least some of the operations of the sequences 1100 and 1200 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It is to be understood that the operations and functionality of the described UE 85 and of the components of the 5G CN 10, their constituent components, and associated processes may be achieved by any one or more of hardware-based, software-based, and firmware-based elements. Such operational alternatives do not, in any way, limit the scope of the present disclosure.

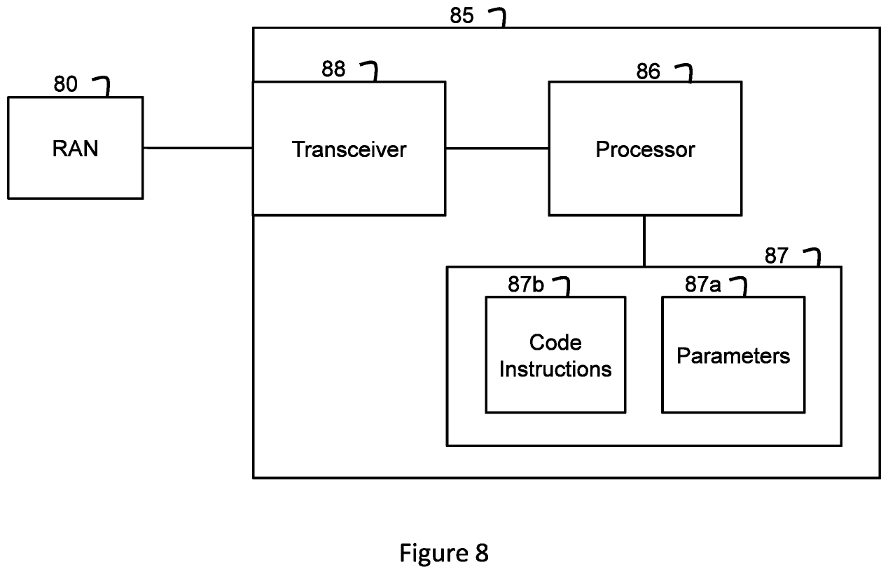

For example, FIG. 8 is a schematic block diagram of a user equipment (UE) 85 according to an embodiment of the present technology. The UE 85 comprises a processor or a plurality of cooperating processors (represented as a processor 86 for simplicity), a memory device or a plurality of memory devices (represented as a memory device 87 for simplicity), and a transceiver 88 allowing the UE 85 to communicate with the 5G CN 10 via the RAN 80. The processor 86 is operatively connected to the memory device 87 and to the transceiver 88. The memory device 87 includes a storage for storing parameters 87a, including for example and without limitation the above-mentioned permanent and temporary identifiers. The memory device 87 may comprise a non-transitory computer-readable medium for storing code instructions 87b that are executable by the processor 87 to allow the UE 85 to perform the various tasks allocated to the UE 85 in the sequences 1100 and 1200.

One aspect of the present technology provides an authentication method in the Extensible Authentication Protocol (EAP) framework. Another aspect illustrated in FIG. 6c describes an application of said method to the 5G secondary authentication. These embodiments do not set the boundaries of the present technology. As such, at sub-operation 630, any entity that may perform the functionalities of the AMF 30 in the procedures of FIGS. 7a, 7b and 7c may be used as a “Network Guardian”. Similarly, any entity that may perform the functionalities of the UE 85 in the procedures of FIGS. 7a, 7b and 7c may be used as an “EAP Client” Likewise, any entity that may perform the functionalities of the SMF 35 in the procedures of FIGS. 7a, 7b and 7c may be used as an “Authenticator”. Also, any entity that may perform the functionalities of the DN-AAA server 76ᵢ in the procedures of FIGS. 7a, 7b and 7c may be used as an “EAP Server”.

### IV. Experimental Results of the EAP-ZKP Protocol

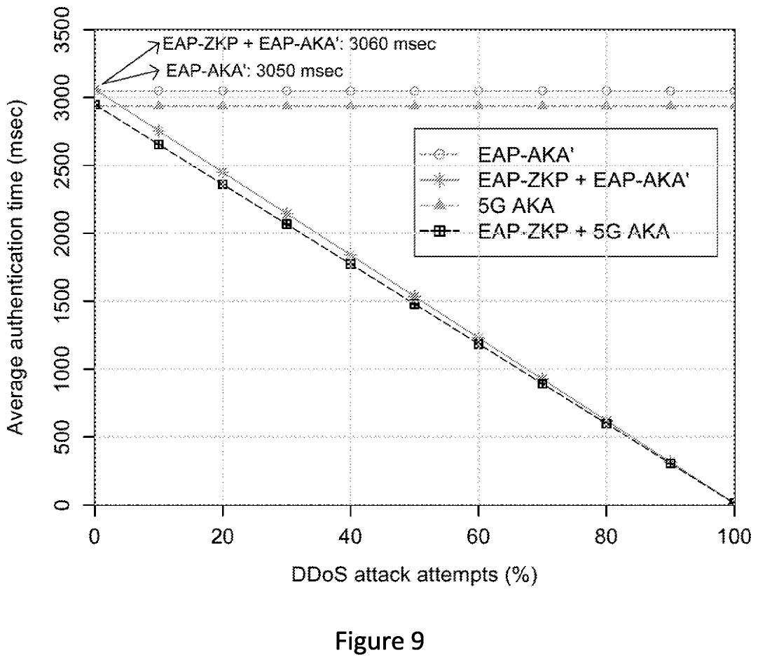

FIG. 9 is a line chart showing average authentication times for the EAP-ZKP authentication protocol according to an embodiment of the present technology for different numbers of DDoS attack attempts compared with average authentication times of different authentication protocols. For example, the EAP-ZKP protocol may be implemented at the AMF 30 such that the UE 85 first runs the EAP-ZKP authentication protocol with AMF 30. If authentication of the UE 85 by the AMF 30 fails, the AMF 30 prevents the UE 85 from continuing authentication with the 5G CN 10 (e.g. with the AUSF 40). If authentication of the UE 85 by the AMF 30 is successful, the authentication procedure continues with the AUSF 40 using, for example, the 5G AKA protocol or the EAP-AKA′ protocol. In the context of the present disclosure, executing the EAP-ZKP protocol between the UE 85 and the AMF 30 and further executing, if authentication by the AMF 30 is successful, the EAP-AKA protocol between the UE 85 and the AUSF 40 is referred to as a EAP-ZKP+EAP-AKA combination Similarly, executing the EAP-ZKP protocol between the UE 85 and the AMF 30 and further executing, if authentication by the AMF 30 is successful, the EAP-AKA′ protocol between the UE 85 and the AUSF 40 is referred to as a EAP-ZKP+EAP-AKA′ combination. As shown, the average authentication time when there is no DDoS attack attempts (i.e. 0% DDoS attack attempts) is around 3.05 seconds and 2.9 seconds when the authentication is executed based on the EAP-AKA′ protocol and the 5G AKA protocol respectively. When there are no DDoS attack attempts, executing the first ZKP authentication procedure (i.e. operations 225 to 285 of the sequence 1200) of the EAP-ZKP authentication protocol between the UE 85 and the AMF 30, and executing the EAP-AKA′ protocol between the UE 85 and the AUSF 40 (said combination of the first ZKP authentication procedure and the EAP-AKA′ protocol being referred to as EAP-ZKP+EAP-AKA′) has an average authentication time of 3.06 seconds. Similarly, when there are no DDoS attack attempts, executing the first ZKP authentication procedure (i.e. operations 225 to 285 of the sequence 1200) of the EAP-ZKP authentication protocol between the UE 85 and the AMF 30, and executing the 5G-AKA protocol between the UE 85 and the AUSF 40 (said combination of the first ZKP authentication procedure and the 5G-AKA protocol being referred to as EAP-ZKP+5G-AKA) has an average authentication time of 2.91 seconds.

However, as it may be seen on FIG. 9, the average authentication times for EAP-ZKP+EAP-AKA′ and EAP-ZKP+5G-AKA compared to EAP-AKA′ protocol and 5G-AKA protocol decreases when the number of DDoS attack attempts increases. For example, for 80% of DDoS attack attempts, the average authentication time is less than one second for EAP-ZKP+EAP-AKA′ and EAP-ZKP+5G-AKA, compared to more than three seconds for EAP-AKA′ and 5G-AKA protocols.

It will be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

1. An authentication method for a target device, comprising:
authenticating, at an access network, a first identity of the target device for registering on the access network;
in response to a successful authentication of the first identity by the access network, executing, at the access network, a zero-knowledge proof (ZKP) protocol to authenticate a second identity of the target device for accessing a service provider; and
in response to a successful authentication of the second identity, granting, by the access network, access of the target device to the service provider.

2. The authentication method of claim 1, further comprising receiving a registration request from the target device at the access network, wherein authenticating the first identity of the target device is made in response to receiving the registration request.

3. The authentication method of claim 1, further comprising receiving a service request from the target device at the access network, wherein executing the zero-knowledge proof protocol to authenticate the second identity of the target device is made in response to receiving the service request.

4. The authentication method of claim 1, further comprising a setup phase, the setup phase comprising:
generating, at the target device, a first credential identity, a second credential identity, and a credential secret, the first and second credential identities and the credential secret being associated with the second identity of the target device;
transmitting, by the target device on a communication channel to an authentication managing entity, a second information comprising the first and second credential identities and the credential secret;
transmitting, by the authentication managing entity on the communication channel to the target device, a first set of partial credential keys, the partial credential keys of the first set of partial credential keys being based on the first and second credential identities and on the credential secret;
transmitting, by the authentication managing entity on the communication channel to a first authenticating entity of the access network, the first credential identity and a second set of partial credential keys; and
transmitting, by the authentication managing entity on the communication channel to a second authenticating entity of the access network, the second credential identity and the second set of partial credential keys.

5. The authentication method of claim 4, wherein the first credential identity and the second credential identity are generated based on random selection among a plurality of credential identities.

6. The authentication method of claim 4, wherein the setup phase is executed before authenticating the second identity of the target device for accessing the service provider.

7. The authentication method of claim 4, wherein the execution of the ZKP protocol comprises, after receiving the service request:
executing, by the first authenticating entity of the access network, a first ZKP authentication procedure to determine whether the target device has a valid first credential identity and a valid credential secret without revealing the credential secret to the first authenticating entity; and
in response to determining, based on a result of the first ZKP authentication procedure, that the target device has a valid first credential identity and a valid credential secret, executing, by the second authenticating entity of the access network, a second ZKP authentication procedure to determine whether the target device has a valid second credential identity and a valid credential secret without revealing the credential secret to the second authenticating entity;
wherein the authentication managing entity grants access of the target device to the service provider in response to determining, based on a result of the second ZKP authentication procedure, that the target device has a valid second credential identity and a valid credential secret.

8. The authentication method of claim 7, wherein executing, by the first authenticating entity of the access network, the first ZKP authentication procedure comprises transmitting, by the target device on the access network to the first authenticating entity, a subset of the first set of partial credential keys.

9. The authentication method of claim 7, wherein executing, by the second authenticating entity of the access network, the second ZKP authentication procedure comprises transmitting, by the target device on the access network to the second authenticating entity, a subset of the first set of partial credential keys.

10. An authentication method for a user equipment (UE) communicably connected to a 5G access network (AN), the authentication method comprising:
executing, at the 5G AN, a primary authentication of the UE for registering on the 5G AN;
in response to a successful primary authentication of the UE, executing, at the 5G AN, a secondary authentication of the UE for accessing a service provider based on a zero-knowledge proof protocol; and
in response to a successful secondary authentication, granting, by the 5G AN, access of the UE to the service provider.

11. The authentication method of claim 10, wherein executing, at the 5G AN, the secondary authentication of the UE comprises transmitting an identity request from a session management function (SMF) to the UE.

12. The authentication method of claim 10, wherein granting, by the 5G AN, access of the UE to the service provider comprises receiving at the SMF, a signal indicative of a success of an execution of the zero-knowledge proof protocol.

13. The authentication method of claim 10, wherein the primary authentication is executed by a authentication server function (AUSF) of the 5G AN based on a protocol selected from a group of protocols comprising: fifth generation authentication and key agreement (5G AKA) protocol and improved extensible authentication protocol-authentication and key agreement (EAP-AKA′) protocol.

14. The authentication method of claim 10, further comprising receiving a registration request from the UE at the 5G AN, wherein the primary authentication is executed in response to receiving the registration request.

15. The authentication method of claim 10, further comprising receiving a packet data unit (PDU) session establishment request from the UE at the 5G AN, wherein executing the secondary authentication based on the zero-knowledge proof protocol is made in response to receiving the PDU session establishment request.

16. The authentication method of claim 10, further comprising a setup phase, the setup phase comprising:
generating at the UE a first credential identity, a second credential identity, and a credential secret associated with the secondary authentication of the UE;
transmitting, by the UE on a communication channel to a server of the service provider, a second information comprising the first and second credential identities and the credential secret;
transmitting, by the server of the service provider on the communication channel to the UE, a first set of partial credential keys, the plurality of partial credential keys being based on the first and second credential identities and on the credential secret;
transmitting, by the server of the service provider on the communication channel to an access and mobility management function (AMF) of the 5G AN, the first credential identity and a second set of partial credential keys; and
transmitting, by the server of the service provider on the communication channel to a data network-authentication, authorization and accounting (DN-AAA) server of the access network, the second credential identity and the second set of partial credential keys.

17. The authentication method of claim 16, wherein the first credential identity is a 5G subscription permanent identifier (SUPI) of the UE, and the second credential identity is a service provider user identifier (SP user ID).

18. The authentication method of claim 16, wherein the setup phase is executed before executing the secondary authentication of the UE for registering on the 5G AN.

19. The authentication method of claim 16, wherein the execution of the secondary authentication based on the ZKP protocol comprises:
executing, by the AMF, a first ZKP authentication procedure to determine whether the UE has a valid first credential identity and a valid credential secret without revealing the credential secret to the AMF; and
in response to determining, based on a result of the first ZKP authentication procedure, that the UE has a valid first credential identity and a valid credential secret, executing, by the DN-AAA server of the access network, a second ZKP authentication procedure to determine whether the UE has a valid second credential identity and a valid credential secret without revealing the credential secret to the DN-AAA server;
wherein the 5G AN grants access of the UE to the service provider in response to determining, based on a result of the second ZKP authentication procedure, that the UE has a valid second credential identity and a valid credential secret.
